(19) United States
(12) Patent Application Publication
(10) Pub. No.: US 2026/0289274 A1
(43) Pub. Date: Sep. 24, 2026

(54) SYSTEM

(71) Applicant: SoftBank Group Corp., Tokyo (JP)

(72) Inventor: Hiroma SAGO, Tokyo (JP)

(73) Assignee: SoftBank Group Corp., Tokyo (JP)

(21) Appl. No.: 19/567,277

(22) Filed: Mar. 16, 2026

(30) Foreign Application Priority Data
Mar. 19, 2025 (JP) 2025-045273

(51) Int. Cl. G06N 3/0475; G06F 40/30; G06N 5/01

(52) U.S. Cl. CPC G06N 3/0475; G06F 40/30; G06N 5/01

(57) ABSTRACT

A system includes a processor that is configured to execute an interactive agent for receiving application matters from a user, analyze the received application matters by using a natural language processing technique, and distribute the analyzed application matters to an appropriate business processing unit based on an analysis result, analyze an emotion of the user by analyzing text input and voice input from the user to identify an emotional state, report a result of business processing to the user via the interactive agent, and use a generative artificial intelligence model to generate a prompt sentence based on natural language input from the user and optimize the business processing by using the generated prompt sentence.

### CROSS-REFERENCE TO RELATED APPLICATION

This application is based on and claims priority under 35 USC 119 from Japanese Patent Application No. 2025-045273 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional business processing systems that use chatbots or interactive agents generally focus on simple intent recognition and routing of user requests. Such systems typically lack sophisticated emotion analysis of the user and do not effectively leverage generative artificial intelligence models to dynamically optimize business processing based on user context. As a result, user requests such as application matters are not always routed to the most appropriate business processing unit, and the system cannot adapt its responses or processing strategies according to the user's emotional state. Furthermore, existing systems do not sufficiently utilize generative AI models to generate prompt sentences from natural language input in a way that directly improves the efficiency and accuracy of downstream business processing. In addition, even when such systems are successfully deployed internally, there is no integrated mechanism for packaging the operational know-how and system configuration for external sales, making it difficult to commercialize and reuse the accumulated expertise. Accordingly, there is a need for a system that can accept and analyze user application matters using natural language processing, perform emotion analysis on user inputs, utilize a generative AI model to generate effective prompts for optimizing business processing, and support external commercialization including internal operational know-how.

### SUMMARY

In order to solve the above problems, a system according to the present invention comprises a processor configured to execute an interactive agent for receiving application matters from a user. The processor analyzes the received application matters by using a natural language processing technique and distributes the analyzed application matters to an appropriate business processing unit based on an analysis result. The processor further analyzes an emotion of the user by analyzing text input and voice input from the user to identify an emotional state, and reports a result of the business processing to the user via the interactive agent. Moreover, the processor uses a generative artificial intelligence model to generate a prompt sentence based on natural language input from the user and optimizes the business processing by using the generated prompt sentence. In one aspect, the processor analyzes the application matters from the user and distributes the application matters to an appropriate business processing unit and an emotion analysis unit. In another aspect, the processor sells the system including operational know-how to external customers after internal utilization, and further uses the generative artificial intelligence model to generate a prompt sentence based on the natural language input from the user and instructs the business processing unit to perform a specific processing by using the generated prompt sentence. By these means, the system can perform more accurate routing and processing of user application matters, adapt to the user's emotional state, improve operational efficiency through generative AI based prompt optimization, and facilitate external commercialization of the internally validated system and know-how.

The term “system” refers to an integrated arrangement of hardware and software components, including at least one processor and associated memory and interfaces, that cooperatively execute functions as described in the claims.

The term “processor” refers to one or more hardware processing units, such as a central processing unit (CPU), graphics processing unit (GPU), or dedicated accelerator, capable of executing instructions to perform the functions and operations described in the claims.

The term “interactive agent” refers to a software module or program that conducts bidirectional communication with a user, for example through text or voice, in order to receive user input, provide responses, and mediate interactions between the user and underlying business processing functions.

The term “application matters” refers to user requests or submissions related to business procedures, such as applications, inquiries, approvals, reservations, or other formal or informal requests that are to be processed by a business processing unit.

The term “natural language processing technique” refers to one or more algorithms, models, or methods configured to analyze and interpret human language expressed in text or speech, including but not limited to tokenization, part-of-speech tagging, intent classification, entity extraction, and syntactic or semantic analysis.

The term “business processing unit” refers to a software component, module, service, or subsystem that performs a specific business-related operation or workflow, such as handling applications, updating records, executing transactions, or managing approvals, based on input provided by the interactive agent or processor.

The term “emotion” refers to a psychological or affective state of the user, such as happiness, anger, frustration, satisfaction, or anxiety, that can be inferred from user input and used to adjust system behavior or processing.

The term “text input” refers to any user-generated information provided in a textual form, such as characters, words, or sentences entered via a keyboard, touch interface, or other text entry mechanism.

The term “voice input” refers to user-generated information provided in spoken form, captured through a microphone or other audio input device, and optionally converted into text or features for further analysis.

The term “emotional state” refers to a classification or representation of the user's emotion at a given time, determined by analyzing user input, and may be expressed as discrete categories, continuous values, or multi-dimensional affective vectors.

The term “result of business processing” refers to an outcome or status produced by a business processing unit in response to an application matter, including but not limited to success, failure, approval, rejection, or completion of a specific business task.

The term “generative artificial intelligence model” refers to a machine learning model, such as a neural network-based language model, configured to generate new content, including text, based on input data, learned parameters, and probabilistic or deterministic generation rules.

The term “prompt sentence” refers to a text sequence generated by the generative artificial intelligence model, which is used as an instruction, query, or context to drive, configure, or refine subsequent business processing or other automated operations.

The term “natural language input” refers to user-provided input in a human language, including written text or transcribed speech, that is processed by the system to determine intent, extract information, or generate responses.

The term “optimize the business processing” refers to improving one or more performance aspects of a business processing operation, such as accuracy, speed, resource utilization, user satisfaction, or error reduction, by using the generated prompt sentence or related AI-based guidance.

The term “emotion analysis unit” refers to a software component, module, or service that receives user input data, applies emotion analysis methods, and outputs an inferred emotional state of the user for use by other parts of the system.

The term “operational know-how” refers to knowledge, configuration information, best practices, guidelines, and accumulated experience related to the deployment, tuning, and operation of the system in an actual business environment.

The term “external customers” refers to organizations or entities outside the organization that originally deployed the system internally, to which the system and associated operational know-how can be provided, licensed, or sold.

The term “specific processing” refers to one or more defined operations, tasks, or workflows executed by the business processing unit in response to instructions derived from the generated prompt sentence.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

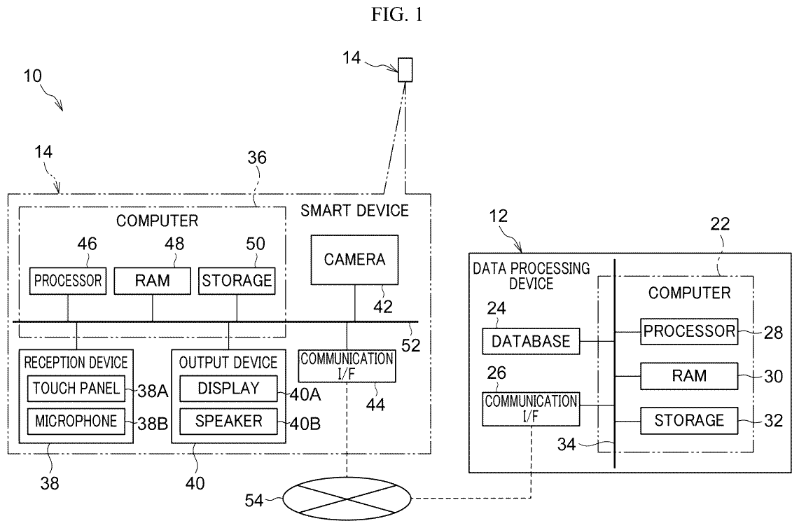

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

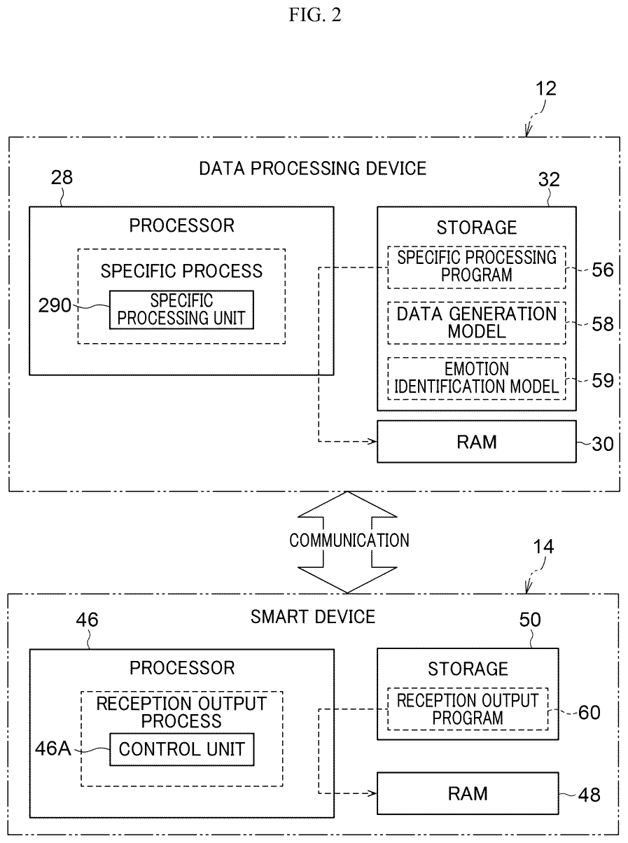

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialog systems that route user requests to business processes suffer from several technical limitations in how they process and manage natural-language interactions at scale. First, many systems rely on static, manually-authored dialog flows and hard-coded prompts. As a result, when input content, missing information, or business rules change, the dialog logic must be reprogrammed, leading to increased processing complexity, rigid behavior, and reduced adaptability of the software architecture. This rigidity often causes excessive round-trips, redundant questions, and inefficient use of computational resources, because the system is not able to dynamically tailor its queries based on the current context of the interaction.

Second, existing architectures typically treat intent classification and prompt generation as independent components with limited shared state. The system may identify a user intent via a natural language processing engine, but then generate follow-up questions using fixed templates that do not fully reflect the detected intent, the set of missing parameters, or the current workflow state. This separation leads to suboptimal data processing: the system repeatedly parses similar input, fails to minimize the number of dialog turns, and cannot reliably extract only the missing parameters. In distributed deployments, this also results in duplicated computations across services, inefficient use of bandwidth, and increased latency for users.

Third, many systems do not maintain a fine-grained, machine-readable representation of business process definition information that is tightly coupled with the state of the ongoing dialog. The mapping from user intent to business process, including required parameters and their completion status, is often implemented in an ad hoc manner or within user-interface code. This makes it difficult to automatically determine which parameters are missing, to feed that information as context to a generative AI model, and to ensure that prompt sentences generated by the model are constrained to request only the information that is actually needed. As the number of business processes and parameters grows, this lack of structured control causes inconsistent question generation, unnecessary or ambiguous prompts, and degraded overall system performance.

Fourth, known approaches generally do not exploit the full interaction history and workflow state as structured context when generating subsequent prompts. Even when a generative AI model is used, the model is often provided with only the latest user message, without explicit, machine-interpretable information about which parameters have already been collected and which business state transitions have already occurred. This leads to prompts that repeat previously asked questions, omit important confirmations, or fail to adapt to corrections requested by the user. Consequently, the system performs additional parsing and validation steps, generates unnecessary network calls, and increases computational load on both the dialog engine and backend workflow components.

Accordingly, there is a need for an improved computer-implemented system and method that (i) integrates structured business process definition information with natural-language understanding, (ii) automatically identifies missing parameters in a process-specific manner, (iii) uses a generative AI model under explicit context control to generate prompt sentences focused on only those missing parameters, and (iv) feeds back workflow state and interaction history into subsequent prompt generation. Such a system should improve the efficiency and determinism of parameter collection, reduce dialog turns, lower processing overhead, and enhance the reliability and scalability of the overall computer-based conversational workflow platform.

The specific processing by the specific processing unit 290 of the data processing device 12 in Example 1 is realized by the following means.

The present invention provides a server comprising a processor and a memory storing instructions which, when executed by the processor, cause the processor to receive input information expressed in natural language from a user via a communication terminal, obtain the input information as character information, convert the character information into a structured data format, and store the structured data; analyze the structured data by using a natural language processing technique to identify a user intent and missing items of required information; acquire, from a storage region, business process definition information that manages a business process corresponding to the user intent, and distribute the input information to the corresponding business process on the basis of an analysis result; generate context information for input to a generative artificial intelligence model on the basis of the business process definition information and the missing items of required information; execute the generative artificial intelligence model by using the context information and cause the generative artificial intelligence model to generate a prompt sentence for acquiring the missing items; structure the generated prompt sentence as message information and transmit the message information to the communication terminal so that the prompt sentence is presented to the user; receive additional input information expressed in natural language from the user in response to the prompt sentence, extract required information from the additional input information by using the natural language processing technique, and store the required information as business data for progressing the business process; and complete the business process on the basis of the stored business data and report a completion result to the communication terminal. This enables the server to tightly couple intent recognition, business process definition information, and controlled use of a generative AI model so that only missing parameters are requested via dynamically generated prompt sentences, interaction history and workflow state are leveraged as explicit context, the number of dialog turns and redundant computations is reduced, and overall efficiency, scalability, and reliability of the computer-implemented conversational workflow processing are significantly improved.

The term “communication terminal” refers to an information processing device operated by a user, such as a mobile device, a desktop device, or a browser-based client, that is capable of transmitting natural-language input to a server and receiving message information, including a prompt sentence, from the server over a communication network.

The term “input information expressed in natural language” refers to information that is provided by a user in a human language, in text form or as text obtained from speech recognition, which is not yet structured according to a predefined data schema.

The term “character information” refers to a representation of the input information as a sequence of symbols or code points, such as encoded text data, that can be processed by a computer system for parsing, analysis, and storage.

The term “structured data format” refers to a machine-readable representation of information in which data elements are organized according to a predefined schema, such as a record, a key-value set, or a hierarchical document, enabling deterministic access and processing by a program.

The term “natural language processing technique” refers to a computational method or algorithm, including but not limited to tokenization, morphological analysis, syntactic parsing, semantic analysis, intent classification, and entity extraction, used to interpret and analyze natural-language text to obtain machine-usable information.

The term “user intent” refers to a machine-interpretable representation of an underlying purpose or goal that a user seeks to achieve through natural-language input, such as initiating a business process, requesting an operation, or modifying stored data.

The term “missing items of required information” refers to data elements or parameters that are defined as necessary for execution or completion of a business process but are not yet present or determinable from the current input information supplied by the user.

The term “storage region” refers to a logical or physical memory resource, such as a database or non-volatile storage subsystem, that stores information including business process definition information, business data, and interaction history for access by a processor.

The term “business process definition information” refers to machine-readable configuration data that specifies at least one business process, including an identifier of the business process, a set of required parameters, parameter types, and processing rules or transitions used to manage progress and completion of the business process.

The term “business process” refers to an executable sequence of operations, executed by a computer system, that relates to a business function, including acquiring parameters, validating data, updating records, and producing a result or outcome for a user or another system.

The term “distribute the input information to the corresponding business process” refers to associating the input information and derived parameters with a selected business process, storing them in a structure linked to that business process, and invoking processing logic for the selected business process based on the analysis result.

The term “generative artificial intelligence model” refers to a trained computational model, such as a neural network-based language model, that is configured to generate text output, including a prompt sentence, in response to input context information, by computing probabilities of output sequences.

The term “context information” refers to structured data supplied to the generative artificial intelligence model that includes at least a representation of the user intent, business process definition information, missing items of required information, workflow state, and interaction history, used to control and constrain generation of a prompt sentence.

The term “prompt sentence” refers to a natural-language sentence generated by the generative artificial intelligence model that requests one or more specific pieces of information from the user, such as missing parameters required for a business process, or provides a confirmation or correction instruction.

The term “message information” refers to data, including at least one prompt sentence and optionally additional metadata, that is formatted in a structured way suitable for transmission from the server to the communication terminal and presentation to the user.

The term “additional input information expressed in natural language” refers to further natural-language information provided by the user in response to a previously presented prompt sentence, which is processed to obtain missing or corrected parameters for the business process.

The term “required information” refers to one or more specific data values extracted from input information, corresponding to defined parameters in the business process definition information, that are needed to execute or complete the business process.

The term “business data” refers to structured, machine-readable records that store values of parameters and related information associated with a business process instance, used by the system to manage execution and completion of that business process.

The term “progressing the business process” refers to updating the state of execution of a business process based on newly acquired business data, including advancing to subsequent steps, invoking additional logic, or preparing final results.

The term “completion result” refers to information representing an outcome of the business process, such as success, failure, or a status with associated details, that is generated by the system after the business process has reached a terminal state and is reported to the communication terminal.

The term “history information” refers to data representing past states and events of an interaction and a business process, including previous user inputs, generated prompt sentences, extracted parameters, and state transitions, which is used as context for subsequent processing.

The term “progress status of the business process” refers to a representation of a current execution state of a business process, such as an intermediate step, a parameter-completion status, or a terminal condition, stored in a machine-readable form.

The term “confirmation prompt sentence” refers to a prompt sentence generated by the generative artificial intelligence model that summarizes at least a portion of the business data and asks the user to confirm, approve, or reject the summarized content.

The term “correction instruction prompt sentence” refers to a prompt sentence generated by the generative artificial intelligence model that instructs the user to modify, correct, or supplement previously provided information relating to the business process.

The term “response content of the user” refers to the semantic content, derived by natural language processing, of a user's natural-language reply to a prompt sentence, including explicit confirmations, rejections, corrections, and newly supplied parameter values.

The term “state of the business process” refers to a machine-readable indication of the current condition of a business process instance, including which steps have been executed, which parameters have been collected, and whether the business process is pending, completed, or requires correction.

In one embodiment, a server cooperates with one or more terminals operated by users to implement the claimed system. The server includes at least one processor, a main memory, a non-volatile storage device, and a network interface. The server executes an operating system such as a general-purpose server operating system and runs application software that implements dialog management, natural language processing, business process management, and interaction with a generative AI model. The terminal includes a processor, a display, an input interface, and a communication module, and executes client software, such as a web browser or a native application, that transmits and receives messages to and from the server over a communication network.

The server stores, in a storage region such as a relational database system and a key-value store, business process definition information, business data, interaction history, and model configuration data. The business process definition information includes, for each business process, a process identifier, a list of required parameters, parameter types, validation rules, and process transition rules. The server stores this information in one or more database tables having fields for process identifiers, parameter names, data types, and state transition conditions. The server also stores association information that maps user intents to process identifiers.

The server obtains input information expressed in natural language from the terminal. The terminal converts user keystrokes or speech-recognition results into character information, encodes the character information as text data, and transmits it via a network protocol. The server receives the text data, decodes it into character sequences, and converts the character sequences into a structured data format such as a structured record or a document object including fields for user identifier, timestamp, original text, and communication channel. The server stores this structured record in a storage region for later access by the dialog processing logic and for use as interaction history.

The server executes a natural language processing module to analyze the structured record. In one example, the server invokes a natural language processing engine that performs tokenization, part-of-speech tagging, named entity recognition, and intent classification. The server represents each input sentence as a sequence of tokens, each token being associated with features such as token index, part-of-speech tag, lemma, and character offset. The server applies an intent classification model, which may be implemented as a neural network-based classifier, such as a feedforward network or a recurrent network, that takes the token sequence or an embedding thereof as input and outputs an intent label and a confidence score. The server also applies an entity extraction model, such as a conditional random field or a sequence tagging neural network, to assign labels to tokens corresponding to parameters such as dates, amounts, or identifiers. The server aggregates the labeled tokens into parameter values and stores the detected intent and parameter values in structured form.

The server acquires business process definition information corresponding to the detected intent by querying the database. The server retrieves the process identifier, the list of required parameters, and metadata such as parameter order and validation rules. The server compares the list of required parameters with the parameters already extracted from the current and past user inputs stored in the interaction history. The server determines which required parameters are missing by computing a set difference between the required parameter set and the set of parameters that have non-empty, validated values. The server stores the missing parameter list as part of the workflow state associated with the current interaction.

The server generates context information for input to a generative AI model. The server constructs a context object that includes at least the process identifier, the detected intent, the list of missing parameters, the list of filled parameters and their values, and the current progress status of the business process. The server may additionally include a summary of previous prompt sentences and user responses. The server formats this context object as a sequence of tokens or as a structured input according to the interface of the generative AI model. For example, the server concatenates the process identifier, parameter names, and their statuses into a control string that guides the generative AI model to generate a prompt sentence that specifically requests only the missing parameters.

In one embodiment, the server executes the generative AI model on a computing platform including one or more graphics processing units. The generative AI model is implemented as a transformer-based neural network including multiple self-attention layers, feedforward layers, layer normalization components, and embedding layers. The model includes trainable parameters representing weights and biases, which are stored in memory and loaded into specialized computation units on the processor or the graphics processing units. The model receives tokenized context information as input, computes attention scores between tokens, generates contextualized embeddings through matrix multiplications and non-linear activation functions, and outputs a sequence of tokens representing a prompt sentence.

The server trains the generative AI model before deployment or fine-tunes a pre-trained model on domain-specific data. During training, the server uses training data consisting of examples of business process contexts and desired prompt sentences. The server encodes each training example as an input context sequence and a target output sequence. The server computes a loss function such as cross-entropy between the predicted token distribution and the target tokens at each position. The server updates the model parameters by a gradient-based optimization algorithm such as stochastic gradient descent or an adaptive optimizer. The server may perform data augmentation by synthesizing additional training examples where missing parameter sets and confirmation scenarios are varied, to improve robustness across different process configurations.

The server controls the generative AI model through explicit context information so that the model does not generate arbitrary conversational text but instead produces prompt sentences constrained by the business process definition information. For example, when the server determines that parameters “start_date” and “end_date” are missing, the server encodes this information in the context and causes the generative AI model to output a sentence such as: “Please tell me the start date and end date of your vacation.”

When the server detects that all required parameters are collected and that the business process is ready for confirmation, the server modifies the context to include filled parameters and a signal indicating that a confirmation prompt is required. In such a case, the generative AI model outputs a sentence such as:

“Your vacation request is from March 10 to Mar. 15, 2026. Do you want to submit this request?”

When the server receives user input that indicates a change, the server updates the workflow state, recalculates missing or corrected parameters, and instructs the generative AI model to produce a correction instruction prompt sentence such as:

“Please enter your new postal address, including postal code, city, street, and building name.” The server thus uses the generative AI model in a controlled, process-aware manner that is distinct from conventional free-form chat systems.

The server uses structured data representations for all intermediate states. The server stores workflow state in records that include fields for process identifier, list of required parameters, list of filled parameters, missing parameter list, and business process status. The server indexes these records by user identifier and session identifier, enabling efficient retrieval and update. By separating business process definition information from runtime workflow state, the server can handle many concurrent workflows and dynamically adapt to changing process definitions without recompiling dialog logic.

The server improves computer technology in multiple ways. The server reduces the number of dialog turns and redundant computational operations by precisely determining missing parameters from a structured comparison between required parameters and already collected parameters. This reduces the number of times the server must call natural language processing and reduces the number of network messages between the server and the terminal.

The server reduces processing latency by limiting the generative AI model's output to concise, task-focused prompt sentences rather than long, unconstrained responses. This leads to fewer tokens to compute in the transformer model and therefore fewer matrix multiplications per interaction. The server improves data management by storing all parameter states and prompt histories in normalized data structures, enabling deterministic replay, auditing, and error analysis.

The server also improves accuracy of parameter collection by using the generative AI model to ask for only missing and relevant parameters. In conventional systems using fixed templates, the system may repeatedly ask for information the user has already provided, leading to ambiguity and user dropout. In contrast, the server enforces a rule that the context always reflects the current parameter completion state. The generative AI model is thus prevented from requesting already filled parameters, which reduces error rates in subsequent parameter extraction and validation. The server thereby lowers the probability of inconsistent or contradictory entries in the business data.

The server internally distinguishes between confirmation prompt sentences and correction instruction prompt sentences. The server determines which type of prompt is required by evaluating workflow rules stored in the business process definition information. If all required parameters are filled and pass validation checks, the server generates a context flag for confirmation. If validation fails or the user indicates dissatisfaction, the server generates a context flag for correction. The generative AI model receives these flags and produces a prompt type accordingly. This architecture imposes a non-conventional rule set on a generative model, preventing it from following generic conversational patterns and instead conforming to strict process-aware behavior.

The server further controls the generative AI model by using custom tokens or control codes embedded into the context to indicate the type of prompt, the maximum allowed length, and the language. The server may encode control instructions such as “ASK_ONLY_MISSING_PARAMETERS” or “GENERATE_CONFIRMATION” into the input sequence. The transformer model learns during training that these control codes modify the generation distribution. As a result, when the server sets a specific control code, the generative AI model concentrates its probability mass on prompt sentences that comply with the desired constraint. This reduces the need for post-processing and improves computational efficiency.

The server employs a modular architecture separated into at least a communication module, a natural language understanding module, a business process management module, a generative AI interaction module, and a data storage module. The communication module manages message reception and transmission between the server and the terminal. The natural language understanding module parses input text, computes embeddings, and performs intent and entity recognition. The business process management module maintains workflow state, performs parameter comparison, and retrieves process definitions. The generative AI interaction module constructs context information, calls the generative AI model, and validates generated prompt sentences. The data storage module persists all entities, including process definitions, workflow states, and log entries. This separation of concerns allows each module to be optimized independently; for instance, the generative AI interaction module can be deployed on dedicated hardware accelerators to increase throughput.

The terminal presents prompt sentences received from the server to the user in a user interface. The terminal may render each prompt sentence as a message bubble and provide an input field for the user's reply. The terminal may also highlight entities recognized in previous messages, such as dates or addresses, to help the user understand what has been detected by the server. The terminal transmits the user's natural language responses back to the server, where the same natural language processing and workflow update mechanisms apply. Because the server sends only concise, targeted prompt sentences, the terminal does not need to perform heavy computation, and network traffic between the terminal and the server is minimized.

The user interacts with the system by reading prompt sentences displayed on the terminal and entering responses in natural language. The user does not need to understand the internal data structures or process definitions. However, because the server generates prompt sentences that accurately reflect the current workflow state, the user experiences fewer clarification questions and can complete interactions more quickly. This human experience is a consequence of the server's technical configuration—particularly its integration of business process definition information, structured workflow state, and controlled generative AI behavior—and not merely a result of automating existing human procedures.

In another embodiment, the server deploys multiple generative AI models with different sizes or architectures. The server selects a model based on factors such as the complexity of the prompt sentence, the number of missing parameters, or system load. For example, the server may use a smaller, computationally cheaper model to generate simple prompts when only one parameter is missing, and a larger, more capable model when complex confirmations involving multiple parameters are required. The server maintains a model selection policy and stores thresholds for switching models. This arrangement allows the server to optimize resource usage and reduce latency, while still producing accurate and context-aware prompt sentences.

In a further embodiment, the server performs online adaptation of the generative AI model by collecting interaction logs and periodically updating fine-tuning data. The server monitors metrics such as the number of turns required to complete a business process, the frequency of user corrections, and the rate of invalid parameter combinations. The server identifies patterns where generated prompt sentences frequently lead to corrections or misunderstandings and uses such patterns to generate additional training examples. The server retrains or fine-tunes the generative AI model with these examples using supervised learning, adjusting weights so that future generations avoid problematic phrasing. This feedback loop yields gradual improvements in precision and efficiency of prompt sentence generation, demonstrating a technical improvement to the underlying model and not merely a one-time configuration.

In yet another embodiment, the server uses the same structured context used for the generative AI model to drive other automated modules, such as rule-based validators or simulation engines, which check for conflicts or inconsistencies before the server commits final business data. Because the context includes complete information about filled and missing parameters, the server can detect inconsistencies earlier, reducing the probability of costly rollbacks or error corrections at later stages. The tight coupling of generative prompt control and deterministic validation logic reduces error propagation and enhances reliability of the overall system.

Through these embodiments, the server, the terminal, and the user cooperate in a configuration where the server executes concrete data structures, algorithms, and model control procedures that improve computer functionality. The system as a whole is not limited to abstract data processing; instead, it realizes specific technical effects such as reduced computational overhead, lower network utilization, improved accuracy and determinism in parameter collection, and enhanced scalability of dialog-driven workflows in complex computing environments.

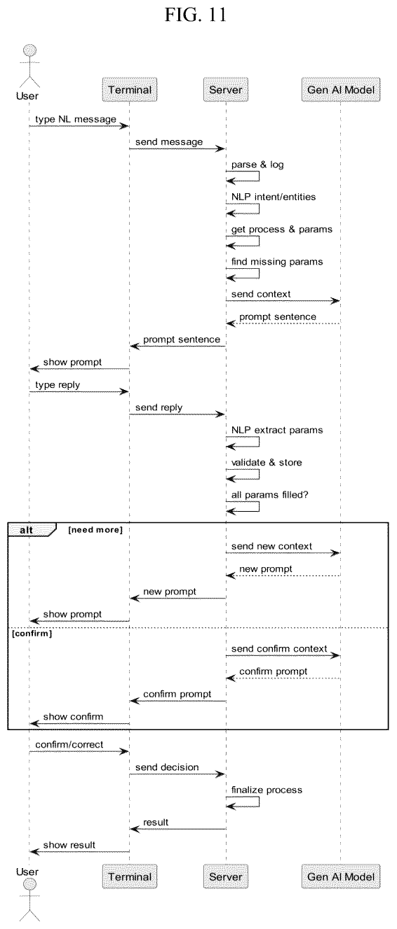

The following describes the processing flow using FIG. 11.

### Step 1:

User operates the terminal and inputs a natural-language message, such as “I want to apply for vacation.”

Input: Keystrokes or speech recognized text on the terminal.

Terminal converts the input into a character string, associates metadata such as user identifier and timestamp, and packages the data as a structured message object.

Output: A structured message object containing the natural-language text and metadata, ready to be transmitted to the server.

### Step 2:

Terminal transmits the structured message object to the server over a communication network.

Input: The structured message object generated in Step 1.

Terminal encodes the object into a network payload, applies a transport protocol, and sends the payload via the network interface.

Output: A network request received by the server that encapsulates the user's natural-language input and associated metadata.

### Step 3:

Server receives the network request and decodes the structured message object.

Input: The network request sent from the terminal.

Server terminates the communication session, parses the payload, and converts the raw bytes into a structured record stored in main memory, including fields such as user identifier, original text, and timestamp.

Output: An in-memory structured record representing the user's natural-language input and metadata.

### Step 4:

Server performs initial logging and persistence of the structured record.

Input: The in-memory structured record from Step 3.

Server writes a log entry to a storage device, indexes the record by user identifier and timestamp, and optionally assigns a session identifier. These operations involve formatting strings, writing to persistent storage, and updating index structures.

Output: A persisted interaction record and an associated session identifier, forming part of the interaction history.

### Step 5:

Server executes a natural language processing module to extract user intent and preliminary entities.

Input: The user's natural-language text retrieved from the structured record.

Server tokenizes the text into tokens, generates embeddings, and applies an intent classification model and an entity extraction model. The models compute vector-matrix multiplications and non-linear activations to output an intent label, a confidence score, and labeled token spans corresponding to entities.

Output: An intent object containing the intent label and confidence score, and an entity list containing candidate parameter values and positions.

### Step 6:

Server validates the intent and entities against predefined thresholds and rules.

Input: The intent object and entity list from Step 5.

Server compares the confidence score with a threshold, discards low-confidence entities, and applies rule-based checks to ensure entity types and formats are consistent with expected categories.

Output: A validated intent object and a cleaned entity set that are suitable for business process mapping.

### Step 7:

Server maps the validated intent to business process definition information.

Input: The validated intent object from Step 6.

Server queries a process definition storage, using the intent label as a key, and retrieves corresponding business process definition information that includes a process identifier, required parameter list, and validation rules.

Output: A business process definition object associated with the current intent.

### Step 8:

Server determines which required parameters are missing for the current business process.

Input: The business process definition object and the cleaned entity set from Steps 6 and 7.

Server computes a set difference between the set of required parameters defined in the process and the set of parameters present in the entity list. The server also checks the interaction history to include previously collected parameters for this session.

Output: A missing parameter list and a filled parameter list for the current business process instance.

### Step 9:

Server updates workflow state for the current session.

Input: The process identifier, missing parameter list, and filled parameter list from Step 8.

Server writes or updates a workflow state record in a workflow state storage, including the process identifier, parameter completion status, and current progression stage. The server may also store a timestamp and a correlation identifier.

Output: An updated workflow state object that reflects the current parameter completion status for the process.

### Step 10:

Server generates context information to control a generative AI model.

Input: The workflow state object, the business process definition object, and the interaction history.

Server composes a context structure that includes the process identifier, the list of missing parameters, the list of filled parameters and their values, the type of prompt required (e.g., data request or confirmation), and a condensed summary of previous prompts and user responses. The server formats this structure as a sequence or structured representation expected by the generative AI model.

Output: A context object prepared for input into the generative AI model.

### Step 11:

Server invokes the generative AI model to generate a prompt sentence.

Input: The context object from Step 10.

Server encodes the context as tokens, sends them to a transformer-based neural network running on a processor or on one or more accelerators, and obtains output tokens. Inside the model, the server executes attention calculations, feedforward transformations, and softmax operations to generate a probability distribution over next tokens, sampling or selecting tokens until a termination condition is met.

Output: A generated prompt sentence in natural language, represented as a character string.

### Step 12:

Server post-processes the generated prompt sentence for safety and compliance with constraints.

Input: The generated prompt sentence from Step 11 and the context object.

Server checks the prompt sentence length, ensures that the prompt sentence refers only to missing parameters, and applies filters or pattern checks to remove disallowed content. If the check fails, the server may adjust the context and re-invoke the generative AI model.

Output: A validated prompt sentence that is consistent with the business process definition and system policies.

### Step 13:

Server constructs a response message for the terminal.

Input: The validated prompt sentence and the workflow state object.

Server creates a response structure including the prompt sentence, the process identifier, and optionally information about the expected type of user input. The server serializes the response into a payload suitable for network transmission.

Output: A response payload containing the prompt sentence and related metadata, ready to be sent to the terminal.

### Step 14:

Terminal receives the response payload and renders the prompt sentence to the user.

Input: The response payload transmitted by the server.

Terminal parses the payload, extracts the prompt sentence and display metadata, and updates the user interface by inserting the prompt sentence into a display area and activating an input field. The terminal may scroll the view and highlight important tokens.

Output: A displayed prompt sentence on the terminal screen, visible to the user and associated with an active input field.

### Step 15:

User reads the prompt sentence and provides additional natural-language input.

Input: The displayed prompt sentence indicating which information is required, such as “Please tell me the start date and end date of your vacation.”

User interprets the request and enters a response, for example, “From March 10 to Mar. 15, 2026.” or “Please enter your new postal address, including postal code, city, street, and building name.” followed by the new address.

Output: A new natural-language response captured by the terminal as character information.

### Step 16:

Terminal packages and sends the user's additional input to the server.

Input: The user's new natural-language response from Step 15.

Terminal encodes the text, attaches session and process identifiers, and transmits the data to the server through the communication module.

Output: A network request containing the user's additional natural-language input and context identifiers, arriving at the server.

### Step 17:

Server processes the additional input to extract specific parameter values.

Input: The new natural-language input from the terminal and the workflow state object.

Server runs the natural language processing module again, but with constraints determined by the missing parameter list. The server applies entity extraction focusing on the parameter types that are still missing, such as date ranges or address fields, and converts them into normalized formats (for example, standardized date formats or structured address components).

Output: A parameter update set that contains values for one or more previously missing parameters.

### Step 18:

Server validates and integrates the newly extracted parameters into business data.

Input: The parameter update set and the business process definition information.

Server applies validation rules, such as checking date order or verifying that address fields are not empty. If validation succeeds, the server writes the parameter values into a business data record associated with the current process instance. If validation fails, the server records an error state and triggers generation of a corrective prompt in subsequent steps.

Output: An updated business data record containing validated parameters, and an updated workflow state that reflects reduced or eliminated missing parameters.

### Step 19:

Server determines whether the business process requires further data collection or confirmation.

Input: The updated workflow state and the business process definition information.

Server checks whether all required parameters are filled and validate successfully. If some parameters are still missing or invalid, the server returns to Step 10 to generate another prompt sentence. If all parameters are satisfied and a confirmation step is defined, the server configures the context for a confirmation prompt.

Output: A decision indicating either continuation of data collection or initiation of confirmation or finalization.

### Step 20:

Server generates a confirmation or correction instruction prompt sentence when appropriate.

Input: The workflow state showing completed parameters and a flag indicating whether confirmation or correction is needed.

Server constructs a context that highlights filled parameters and a request type (confirmation or correction), invokes the generative AI model as in Step 11, and obtains a prompt sentence such as “Your vacation request is from March 10 to Mar. 15, 2026. Do you want to submit this request?” or “Please correct the end date so that it is later than the start date.”

Output: A confirmation or correction instruction prompt sentence ready to be sent to the terminal for user response.

### Step 21:

Server finalizes the business process and reports the result to the terminal when completion conditions are met.

Input: The workflow state with all required parameters confirmed and business data fully validated.

Server executes process-specific finalization operations, such as writing final records to persistent storage or notifying downstream systems, then constructs a completion message summarizing the result. The server encapsulates this message in a response payload and transmits it to the terminal.

Output: A completion result message delivered to the terminal, indicating that the process has reached a terminal state.

### Step 22:

Terminal displays the completion result and optionally stores or forwards it.

Input: The completion result message from the server.

Terminal parses the message, renders a final confirmation or status display to the user, and may store a local copy or allow the user to export the result.

Output: A displayed completion status on the terminal and, optionally, stored local data for user reference.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented dialogue systems that receive user requests in natural language and forward such requests to back-end business applications typically rely on fixed rule sets or manually designed intent categories. In such systems, a processor usually performs simple pattern matching or keyword extraction and then selects one of a predefined workflows. As a result, the system often fails to capture subtle variations of user intent, composite requests, or context-dependent instructions, and therefore generates inefficient or incorrect back-end processing. This leads to unnecessary round-trips between the user and the system, redundant database access, and increased processing latency.

Furthermore, in conventional architectures, a natural language interface layer and a business processing layer are loosely coupled: the natural language interface layer passes only a coarse-grained intent label and a small set of parameters, and the business processing layer must reconstruct detailed processing logic using additional rules. Such separation increases system complexity, makes maintenance difficult, and hinders optimization of resource usage in the computing environment.

Additionally, although machine learning models have been used in some systems for intent detection or entity extraction, these models are not generally employed to generate explicit internal instructions that directly drive downstream business processing. As a consequence, the processor cannot flexibly adjust the sequence and granularity of database operations or transaction operations in response to changing user behavior patterns or evolving business rules, which limits the ability to improve throughput and scalability of the overall system. Moreover, many existing systems do not analyze a user's emotional state in a computationally meaningful way, or they only use coarse sentiment indicators to adjust a user-facing message. These systems do not systematically incorporate emotion analysis into the generation of internal instructions for back-end processing, and therefore fail to adapt processing strategies or response wording in a manner that reduces follow-up queries or clarifications. This causes inefficient utilization of processor cycles, network bandwidth, and data storage resources.

In view of the foregoing, there is a need for an improved computer-implemented system in which a processor uses a generative AI model to transform user natural language input and parsed intent information into an explicit prompt sentence that functions as an internal instruction for downstream processing, and in which the processor executes business processing and electronic transaction processing directly according to the prompt sentence while also adjusting processing behavior and response generation based on emotion analysis. Such a system should reduce the number of intermediate mapping layers, decrease the amount of ad-hoc workflow logic, and improve the efficiency, accuracy, and scalability of natural language driven transaction processing in a computing environment.

The specific processing by the specific processing unit 290 of the data processing device 12 in Application Example 1 is realized by the following means.

The present invention provides a server comprising a processor configured to receive, via an interactive agent unit, application matters and other requests expressed in natural language from a user through a terminal, to analyze the received natural language input as character data by using a natural language processing unit that performs at least morphological analysis, syntactic analysis, intent classification, and element extraction to identify an application content, a transaction type, and transaction conditions, to distribute the analyzed natural language input to one or more business processing units and one or more electronic transaction processing units based on the identified application content and the identified transaction type, to generate, by using a prompt generation unit, a prompt sentence as an internal instruction sentence that explicitly describes contents and conditions of processing by calling a generative AI model implemented as an external service or an internal process based on the natural language input and on intent information and element information obtained by the natural language processing unit, to interpret, by using the business processing unit, the generated prompt sentence and execute, in accordance with a processing target, reference conditions, transaction conditions, and verification conditions described in the prompt sentence, at least one of search processing, update processing, and record processing with respect to a data storage region, to execute, by using the electronic transaction processing unit, inquiry processing regarding transaction information, payment information, and account information associated with user identification information and to execute electronic transaction processing including at least balance inquiry, payment amount calculation, and transfer processing based on the prompt sentence, to obtain, by using a reporting unit, processing results from the business processing unit and the electronic transaction processing unit as structured data and generate a natural language response sentence based on the structured data by using at least one of the generative AI model and a template-based sentence generation process and present the generated response sentence to the user via the interactive agent unit, and to analyze, by using an emotion analysis unit, text input or voice input from the user to identify an emotional state of the user and adjust at least one of contents and expressions of the prompt sentence and the response sentence according to the emotional state. This enables the server to convert natural language requests into explicit internal instructions that directly govern database operations and transaction operations, thereby reducing reliance on rigid rule-based workflows, improving the accuracy and efficiency of back-end processing, adapting processing behavior and response generation to user context and emotional state, and enhancing overall performance and scalability of computer-implemented natural language transaction systems.

The term “interactive agent unit” refers to a software component executed by the processor that provides a conversational user interface, receives natural language inputs from a user via a terminal, and presents natural language responses to the user in a dialog format.

The term “terminal” refers to an information processing device operated by a user, including but not limited to a portable device, a stationary device, or a browser-based client, which is configured to transmit natural language input to the server and display responses from the server.

The term “natural language input” refers to character data or audio data representing a human language expression provided by the user, including text messages, spoken utterances converted into text, or any other machine-readable representation of user utterances.

The term “application matters” refers to user requests related to administrative processing, business operations, or service usage, including inquiries, applications, instructions, and transaction-related requests that are expressed in natural language.

The term “natural language processing unit” refers to a functional unit executed by the processor that performs one or more operations for analyzing a natural language input, including at least morphological analysis, syntactic analysis, intent classification, and element extraction.

The term “morphological analysis” refers to processing that segments a natural language input into smaller units such as tokens, words, or morphemes and assigns grammatical or lexical attributes to the segmented units.

The term “syntactic analysis” refers to processing that determines a structural relationship among words or tokens in a natural language input, including assigning parts of speech, identifying dependencies, or generating a parse structure.

The term “intent classification” refers to processing that determines, from a natural language input, a category of user purpose or goal, such as an inquiry, an instruction, or a transaction request, using a classification model or rule set.

The term “element extraction” refers to processing that identifies specific data elements from a natural language input, including but not limited to amounts, dates, entities, account identifiers, and transaction conditions.

The term “application content” refers to semantic information representing what kind of processing or service a user requests through the natural language input, including the type of business operation, inquiry subject, or requested action.

The term “transaction type” refers to a classification of electronic transaction processing indicated by a user request, such as balance inquiry, payment calculation, funds transfer, or other financial or non-financial transaction categories.

The term “transaction conditions” refers to parameters that constrain or specify details of a transaction, including but not limited to an amount, a currency, a date, a period, a source account, a destination account, or other relevant conditions.

The term “distribution unit” refers to a functional unit executed by the processor that determines, based on analysis results, to which one or more processing modules, including business processing units, electronic transaction processing units, and emotion analysis units, a given request or data should be forwarded.

The term “business processing unit” refers to a functional unit executed by the processor that performs non-transactional or transactional business logic, including data retrieval, data update, data aggregation, or other operations on a data storage region according to instructions indicated by a prompt sentence.

The term “electronic transaction processing unit” refers to a functional unit executed by the processor that performs electronic transactions, including balance inquiries, payment amount calculations, funds transfers, or other transaction operations on accounts or transaction records, according to instructions indicated by a prompt sentence.

The term “prompt generation unit” refers to a functional unit executed by the processor that generates a prompt sentence functioning as an internal instruction, based on natural language input, intent information, and element information, by calling or utilizing a generative AI model implemented as an external service or an internal process.

The term “generative AI model” refers to a machine learning model configured to generate text data, including prompt sentences or response sentences, based on input text and optional conditioning information, and implemented using a neural network or another generative algorithm.

The term “prompt sentence” refers to an internal instruction sentence generated by the prompt generation unit, which explicitly describes contents and conditions of processing, including at least a processing target, reference conditions, transaction conditions, and verification conditions used by downstream processing units.

The term “data storage region” refers to a logical or physical storage resource accessible by the processor, including databases, file systems, key-value stores, or other storage systems, in which business data, transaction data, account data, and log data are stored.

The term “search processing” refers to operations executed by the processor for retrieving data from a data storage region according to one or more search conditions, including but not limited to database query execution, index lookup, or filtering operations.

The term “update processing” refers to operations executed by the processor for modifying existing data stored in a data storage region, including but not limited to writing new values, changing field contents, or adjusting status flags.

The term “record processing” refers to operations executed by the processor for creating, storing, or logging data records in a data storage region, including inserting new entries into a database or writing transaction logs.

The term “transaction information” refers to structured data representing operations executed on assets or accounts, including identifiers, timestamps, amounts, counterparties, and status values associated with a transaction.

The term “payment information” refers to data related to payments owed or performed by a user or on behalf of a user, including billing amounts, due dates, payment histories, and payment statuses.

The term “account information” refers to data associated with a user's account, including account identifiers, balances, account types, ownership information, limits, and other account-related attributes.

The term “user identification information” refers to data used to identify or authenticate a user, such as an account identifier, a user identifier, a token, or other credentials or identifiers.

The term “reporting unit” refers to a functional unit executed by the processor that obtains processing results from the business processing unit and the electronic transaction processing unit, converts the results into structured data if necessary, and generates a natural language response sentence based on the structured data.

The term “template-based sentence generation process” refers to a process in which a response sentence is generated by inserting one or more variable values into a predetermined sentence pattern or template.

The term “response sentence” refers to natural language text presented to the user via the interactive agent unit, the text describing results of processing or guiding the user for further interaction.

The term “emotion analysis unit” refers to a functional unit executed by the processor that analyzes text input or voice input from the user to identify an emotional state, such as satisfaction, frustration, urgency, or other affective conditions.

The term “emotional state” refers to an inferred condition representing one or more aspects of the user's affect or attitude, derived from analysis of the user's input and optionally from context or interaction history.

The term “conversation history” refers to stored information representing a sequence of past natural language inputs from the user and corresponding processing histories or system outputs, used as context for subsequent prompt sentence generation.

The term “context-dependent prompt sentence” refers to a prompt sentence generated using not only a current natural language input but also a conversation history, such that the prompt sentence explicitly reflects prior requests, prior responses, or prior processing results.

The term “processing target” refers to a specific data object, record group, account, transaction set, or business domain item that is to be operated on by a business processing unit or an electronic transaction processing unit.

The term “processing conditions” refers to constraints or parameters that define how processing is to be executed, including reference conditions, transaction conditions, and verification conditions described in a prompt sentence.

The term “verification conditions” refers to rules or checks that must be satisfied before a processing operation is executed, such as balance sufficiency checks, authorization checks, or range checks on parameter values.

In one embodiment, a server, one or more terminals, and a user cooperate to implement the invention.

The server includes a processor, a memory, a network interface, and one or more non-transitory storage media. The server runs an operating system such as a general-purpose server operating system, and executes an application program that implements an interactive agent unit, a natural language processing unit, a prompt generation unit, a business processing unit, an electronic transaction processing unit, a reporting unit, and an emotion analysis unit. The terminals are realized as client devices such as smartphones, tablet computers, notebook computers, or desktop computers that execute a web browser or a native application. The user operates the terminal to input natural language requests and view responses.

The terminal executes a browser or application framework such as a web browser or a mobile runtime to render a chat-style user interface. The terminal converts user keystrokes or voice input into character data encoded, for example, in UTF-8, and transmits the character data over a network to the server using a protocol such as HTTPS. The terminal displays, on a graphical display, natural language response sentences and transaction results received from the server.

The server executes the interactive agent unit as an application layer component that terminates HTTPS connections from the terminals, authenticates the user, and maintains a conversation session in the memory. The server stores, for each conversation, a conversation history including past natural language inputs, corresponding prompt sentences, processing results, and timestamps in a structured data format such as records in a relational database table or documents in a document-oriented storage. The server thereby maintains context that is reused for subsequent processing.

The server executes the natural language processing unit using a natural language processing library such as a statistical or neural network-based toolkit. The server performs tokenization, morphological analysis, and syntactic parsing on the character data by using algorithms such as wordpiece tokenization and dependency parsing. The server represents the input sentence as a sequence of tokens, each associated with part-of-speech tags, dependency relations, and position indices. The server then applies an intent classification algorithm implemented, for example, as a neural network-based classifier that receives the token sequence, computes an embedding representation, and outputs a probability distribution over a set of intent labels. The server selects an intent label such as “check_credit_card_payment” or “transfer_money” according to the maximum probability.

The server further executes an element extraction algorithm, implemented as a sequence labeling model, to identify entities such as monetary amounts, temporal expressions, product types, and counterparty references. The server maps each token to a label such as “B-AMOUNT,” “I-AMOUNT,” “B-DATE,” “B-ACCOUNT,” and then aggregates contiguous labels to form normalized elements, for example an amount value (5000) and a currency type. By storing token-level and entity-level information in data structures such as arrays and dictionaries, the server prepares structured input for the subsequent units.

The server executes the prompt generation unit as a distinct software module that interfaces with a generative AI model. In one embodiment, the server implements the generative AI model as a transformer-based neural network trained for conditional text generation. The server represents the intent label, the extracted elements, and the original natural language input as a concatenated input sequence, encodes the sequence into embedding vectors, and feeds the vectors to a multi-layer transformer encoder-decoder network. The server configures the network to have multiple self-attention layers, feed-forward layers, and layer normalization, and to output a sequence of tokens representing a prompt sentence.

The server trains the generative AI model offline using supervised learning. The server prepares training data pairs consisting of user inputs with associated structured annotations and correct prompt sentences. The server minimizes a cross-entropy loss between the predicted tokens and target tokens, and updates model parameters by stochastic gradient descent or an adaptive optimization method. The server may use techniques such as mini-batching, learning rate scheduling, gradient clipping, and data augmentation of natural language examples. The server thereby obtains model parameters that allow the generative AI model to generate explicit internal instruction sentences rather than simply echoing user text.

The server calls the generative AI model at run time to generate a prompt sentence that explicitly specifies processing contents and conditions. The server passes as input the user intent, the extracted elements, and the relevant conversation history so that the model can generate a context-dependent instruction. The generative AI model outputs a natural language text that includes explicit references to processing targets, reference conditions, transaction conditions, and verification conditions. By using the model in this way, the server converts a vague user utterance into a deterministic internal specification that the downstream business processing unit and electronic transaction processing unit can interpret without complex heuristic rules.

The server generates, for example, the following prompt sentences:

“The user requested to know the credit card payment amount for the current month. Retrieve the user's credit card billing information for the current month from the billing database and calculate the total payment amount.”

“The user wants to transfer 5,000 yen to a registered friend. Identify the friend's account information, verify that the user has sufficient available balance, execute the transfer of 5,000 yen if all conditions are satisfied, and record the transaction details in the transaction log.”

The server stores each generated prompt sentence together with metadata such as the user identifier, the timestamp, and the conversation identifier in a dedicated storage region. The server thereby maintains a history of internal instructions that can be audited or reinterpreted if needed.

The server executes the business processing unit as a set of software modules responsible for accessing one or more data storage regions. The server implements the data storage regions as, for example, relational tables for account data, billing data, and transaction logs, and as index structures to accelerate queries. The server parses the prompt sentence using regular expressions, a lightweight parser, or a secondary neural classifier that detects processing verbs (retrieve, calculate, verify, record) and argument phrases (billing information, current month, user's credit card). The server maps each detected instruction to a corresponding database operation. For example, the server constructs a parameterized query for a billing table, with parameters derived from the prompt sentence: user identifier, billing period, and aggregation function.

The server executes the electronic transaction processing unit as a module that controls financial or transactional records. The server interprets the prompt sentence to derive a transaction graph: a source account, a destination account, a transfer amount, and necessary preconditions such as minimum balance and daily limit. The server executes a sequence of database updates or calls to external transaction APIs in a defined order, ensuring atomicity by using transaction control mechanisms such as begin-commit blocks or distributed transaction protocols. Because the prompt sentence contains explicit verification conditions, the server can enforce integrity constraints without relying on ad-hoc application logic scattered across multiple layers.

The server executes the emotion analysis unit as a module that processes textual or transcribed voice input to extract sentiment and fine-grained emotion labels. The server may implement this unit using another neural network, such as a bidirectional encoder that produces an emotion vector representing dimensions such as positivity, urgency, and frustration. The server trains the emotion model by supervised learning on annotated emotion corpora, using a loss function that penalizes incorrect emotion classifications. The server uses the resulting emotion vector to adjust both the prompt sentence and the response sentence.

For instance, the server may add to the prompt sentence internal directives such as “respond with additional explanation because the user appears confused” or “prioritize confirmation steps because the user appears anxious about security,” thereby modifying downstream control flow in a way that cannot be readily achieved by manual rules.

The server executes the reporting unit to transform raw results from the business processing unit and the electronic transaction processing unit into structured data objects. The server supplies these objects to either the generative AI model or a template-based generation process. When the server uses the generative AI model, the server passes both the numeric or symbolic results and the current emotion vector, enabling generation of a response sentence that is not only factually correct but also adapted to the user's emotional state. When the server uses a template-based method, the server selects a template variant according to the emotion vector, such that a concise template is used for neutral states and a more explanatory template is used for negative states.

The server thereby improves computer technology in several ways. First, by introducing an explicit intermediate representation in the form of a prompt sentence generated by a generative AI model, the server reduces the complexity of rule-based mapping from user utterances to database operations. The server replaces large, hard-coded decision trees with a learned mapping that produces structured internal text. This change reduces the number of conditional branches the processor must evaluate per request and enables more efficient utilization of instruction cache and data cache, leading to reduced processing latency.

Second, the server improves accuracy of intent handling and transaction execution because the generative AI model can encode long-range dependencies and contextual information across multiple utterances using attention mechanisms. The server stores and reuses the conversation history, and the transformer architecture applies multi-head attention over the history, enabling accurate disambiguation of pronouns and references such as “that payment” or “the previous transfer.” Such disambiguation would require complex and error-prone custom code in conventional systems.

Third, the server improves data management by aligning prompt sentences with data schema elements. The server constrains the generative AI model during training to produce internal phrases that explicitly reference database table names, field names, and operation types. For example, the server trains the model so that it outputs phrases like “retrieve from billing_table total_amount where user_id= . . . and billing_month= . . . .” Even though the prompt sentence remains natural language, it follows a controlled vocabulary that closely corresponds to the schema, allowing the business processing unit to perform direct mapping to SQL templates or data access methods. This controlled internal language improves maintainability and reduces errors caused by misinterpretation.

Fourth, the server reduces communication load between system components. The server transmits only compact prompt sentences and structured parameter objects between the prompt generation unit and the business or transaction units, instead of large, verbose rule sets or detailed decision graphs. The server also reduces network traffic between the server and the terminal by minimizing follow-up clarification messages, because the improved intent understanding and emotion-aware adjustments decrease the number of incomplete or ambiguous responses.

Fifth, the server executes non-conventional control flows in the AI components that differ from human workflows. The server uses the generative AI model not merely to imitate human operators but to synthesize internal instructions optimized for machine execution. For example, the server can encode, in the prompt sentence, instructions to batch multiple related queries or to prefetch certain data ranges when the model detects patterns in the conversation history indicating upcoming user needs. Such batching and prefetching reduce the number of disk I/O operations per transaction and increase throughput on the database server.

The server configures the generative AI model with hyperparameters such as number of layers, hidden dimension size, number of attention heads, and dropout rate. The server tunes these hyperparameters based on validation performance on a held-out dataset, optimizing a tradeoff between latency and accuracy. The server may implement model quantization or distillation to reduce model size, thereby lowering memory footprint and improving inference speed on the server hardware. These optimizations directly improve computational efficiency and are not achievable simply by delegating tasks to human operators.

The server may employ various alternative embodiments. In one embodiment, the natural language processing unit uses a purely statistical parser and a separate classifier, while the prompt generation unit relies on rule-based templates augmented by a smaller neural language model. In another embodiment, the server integrates the intent classification and prompt generation into a single transformer network that outputs both an intent label and a prompt sentence in a multi-task learning configuration. In yet another embodiment, the server deploys different generative AI models specialized for different domains, such as payments, investments, or support inquiries, and selects an appropriate model according to the detected transaction type.

The server may also vary the storage structures. In one embodiment, the data storage region includes a relational database for primary transaction data and a key-value store for session and emotion state. In another embodiment, the server uses a columnar store for high-volume analytic queries and a log-structured storage for append-only transaction logs. The server maps prompt sentence elements to the corresponding storage engine in order to minimize response time and avoid unnecessary scanning of large datasets.

The server can integrate with external device controllers or external systems to extend technical effects. For example, the server can control an automated teller device or a payment terminal by issuing machine-level commands after executing the electronic transaction processing unit. The server converts internal transaction results into control signals for actuators or display modules, thus connecting the AI-driven internal instruction mechanism with physical-world device control. This further demonstrates that the invention is not limited to abstract data processing but contributes to technical control of real-world equipment.

The user interacts with the terminal without being aware of the internal complexity. The user simply inputs natural language queries, such as “Tell me my credit card payment amount for this month” or “I want to send 5,000 yen to my friend.” The terminal transmits these queries to the server, and the server performs the described processing using the generative AI model, the prompt sentence mechanism, and the structured business and transaction units. The user receives responses such as “Your credit card payment amount for this month is 25,000 yen” or “I have sent 5,000 yen to your friend's account,” and can verify that the underlying transactions have been executed, for example by observing updated balances on the terminal display.

By implementing the invention as described, the server improves core aspects of computer technology: the mapping between unstructured natural language input and structured database and transaction operations, the internal representation used to drive machine-level workflows, the efficiency and accuracy of data access and updates, and the adaptation of processing paths based on emotion analysis. These improvements are achieved through specific system architecture, data structures, and machine-learning-based algorithms, and therefore extend beyond mere automation of human mental processes.

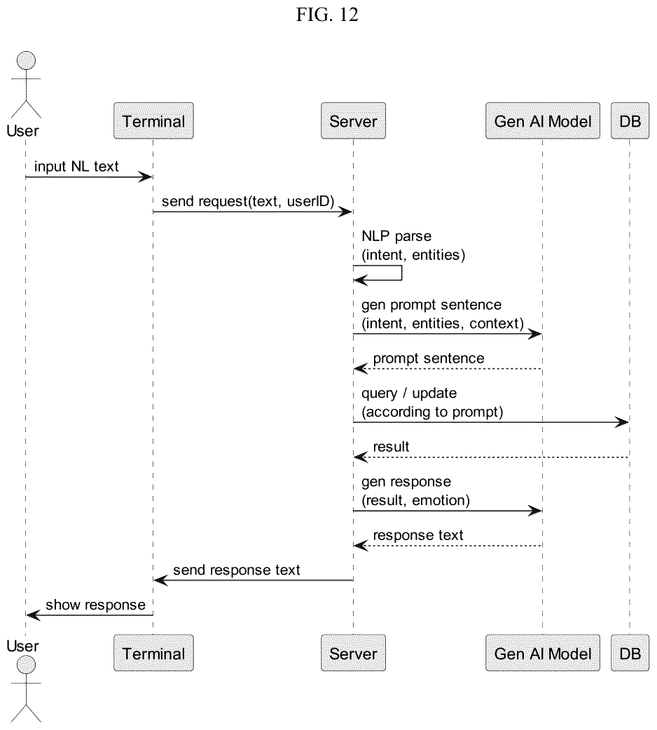

The following describes the processing flow using FIG. 12.

### Step 1:

User operates the terminal to create a natural language request.

User inputs, for example, a sentence such as “Tell me my credit card payment amount for this month” or “I want to send 5,000 yen to my friend” into a chat UI on the terminal.

Terminal receives the keystrokes or voice input, converts voice input into text if necessary, and encodes the text as a character string.

Input: raw user utterance in natural language.

Terminal packages the character string together with user identification information into a request message.

Output: structured request data including user ID and natural language text.

### Step 2:

Terminal sends the structured request data to the server.

Terminal opens a secure network connection using HTTPS and transmits the request as a data packet to a predefined API endpoint of the server.

Input: structured request data including user ID and natural language text.

Terminal formats the data as a message body, for example in a serialized structure, and sends it over the network.

Output: network message delivered to the server.

### Step 3:

Server receives the network message and performs initial parsing.

Server accepts the HTTPS request at a communication interface, decrypts the payload, and parses the message body to extract the user identification information and the natural language text.

Input: network message containing encoded request data.

Server converts the received bytes into internal data structures, such as strings and identifiers, and validates basic syntax and authentication.

Output: internal request object containing user ID, session ID, and raw natural language text.

### Step 4:

Server stores and updates conversation context.

Server retrieves existing conversation history for the session from a storage region and appends the new natural language text to the history.

Input: internal request object and previously stored conversation history.

Server performs a merge operation that combines the new entry with prior turns, maintaining an ordered list of utterances and system actions.

Output: updated conversation history object associated with the user and session.

### Step 5:

Server performs natural language preprocessing on the raw text.

Server applies tokenization, morphological analysis, and syntactic parsing to the natural language text using a natural language processing unit.

Input: raw natural language text from the internal request object.

Server transforms the text into a sequence of tokens, assigns part-of-speech tags, and computes dependency relations, thereby converting unstructured text into structured linguistic features.

Output: token sequence with tags, parse tree, and associated linguistic annotations.

### Step 6:

Server detects user intent and extracts key elements.

Server feeds the annotated token sequence into an intent classification model and an element extraction model.

Input: token sequence with linguistic annotations.

Server computes an embedding representation, passes it through neural network layers, calculates probability scores over possible intents, and selects the highest-scoring intent.

Server simultaneously labels tokens to identify entities such as amounts, dates, account references, and counterparties, and then normalizes these entities into machine-usable values.

Output: structured intent object and a set of extracted elements (for example, {intent: check_credit_card_payment, period: current_month} or {intent: transfer_money, amount: 5000, currency: JPY, recipient label: friend}).

### Step 7:

Server constructs input features for the generative AI model.

Server combines the structured intent object, the extracted elements, and relevant parts of the conversation history into a unified representation.

Input: intent object, element set, and conversation history.

Server serializes this representation into a formatted text or token sequence that encodes both the current request and contextual information, and adds model-specific control tags if needed.

Output: model input sequence prepared for the generative AI model.

### Step 8:

Server generates a prompt sentence using the generative AI model.

Server passes the model input sequence to a transformer-based generative AI model and requests generation of an internal instruction sentence.

Input: model input sequence containing intent, elements, and context.

Server performs a forward pass through the model: the model computes attention weights, updates hidden states layer by layer, and outputs a sequence of tokens that form a coherent prompt sentence specifying processing targets and conditions.

Output: prompt sentence in natural language that explicitly describes what data to access and what operations to perform.

### Step 9:

Server stores and analyzes the generated prompt sentence.

Server associates the prompt sentence with the current request and writes it to a log or prompt store.

Input: generated prompt sentence and current request metadata.

Server applies a lightweight parser or pattern matcher to the prompt sentence to detect operation types, data targets, and constraints, extracting these into structured instruction parameters.

Output: structured instruction object that maps segments of the prompt sentence to concrete operations (for example, database read, write, and verification checks).

### Step 10:

Server distributes processing based on the instruction object.

Server uses a distribution unit to decide which internal modules should handle each part of the instruction.

Input: structured instruction object describing operations and conditions.

Server evaluates rule sets or routing tables to map inquiry-type operations to the business processing unit and transaction-type operations to the electronic transaction processing unit, and optionally routes emotion-related clauses to the emotion analysis unit.

Output: routed tasks and parameters assigned to the business processing unit, electronic transaction processing unit, and emotion analysis unit.

### Step 11:

Server executes business processing for data inquiries and calculations.

Server invokes the business processing unit with inquiry-related parameters extracted from the instruction object.

Input: parameters indicating data targets, such as user ID, data type (for example, credit card billing), and time range.

Server constructs one or more database queries using these parameters, performs search processing in the data storage region, aggregates retrieved records as required, and calculates summary values such as total payment amounts.

Output: business result data, such as computed totals, lists of records, or derived attributes.

### Step 12:

Server executes electronic transaction processing for state-changing operations.

Server invokes the electronic transaction processing unit with transaction-related parameters, such as source account, destination account, amount, and preconditions.

Input: transaction parameters from the instruction object.

Server performs verification operations by comparing requested amounts with available balances and system limits, then, if conditions are satisfied, executes update processing on account records and inserts transaction records into a transaction log.

Output: transaction execution result, including status flags, new balances, and transaction identifiers.

### Step 13:

Server performs emotion analysis on user input.

Server feeds the original or context-enriched user text into an emotion analysis model to derive an emotion vector or label set.

Input: user text and optionally conversation context.

Server computes features such as sentiment polarity, urgency, and frustration level, and maps these to an emotion state representation.

Output: emotion state object that characterizes the user's emotional condition at the time of the request.

### Step 14:

Server adjusts internal instructions and response strategy based on emotion.

Server examines the emotion state object in combination with the instruction object and processing results.

Input: emotion state object, structured instruction object, and result data from business and transaction units.

Server modifies or augments the prompt sentence or internal control flags to, for example, request more detailed explanations, add confirmation steps, or choose safer default options, thereby influencing subsequent data access patterns and response composition.

Output: adjusted control parameters and response strategy description.

### Step 15:

Server composes structured response data.

Server aggregates business result data, transaction execution results, and emotion-adjusted strategy information into a unified response structure.

Input: result data objects from business and transaction processing, and control parameters from emotion-based adjustments.

Server organizes these into a format suitable for either generative or template-based response creation, clearly separating factual content, explanatory content, and metadata such as transaction IDs.

Output: structured response object containing all information required to formulate a user-facing message.

### Step 16:

Server generates a natural language response sentence.

Server either calls the generative AI model again with the structured response object or applies a template-based generation process.

Input: structured response object and, optionally, emotion state.

Server, in the generative case, encodes the structured data into a model input sequence, performs a forward pass through the generative AI model, and obtains a fluent response sentence adapted to the user context and emotional state; in the template case, the server selects an appropriate template and fills placeholders with concrete values.

Output: response sentence in natural language, such as “Your credit card payment amount for this month is 25,000 yen” or “I have sent 5,000 yen to your friend's account. The transaction ID is TX123456789.”

### Step 17:

Server sends the response sentence to the terminal.

Server embeds the response sentence in a response message associated with the user session and transmits it over the network using HTTPS.

Input: natural language response sentence and session identifiers.

Server formats the data for transmission, adds necessary headers, and dispatches the packet to the terminal's network address.

Output: network response message containing the response sentence.

### Step 18:

Terminal receives and displays the response.

Terminal accepts the network response message, parses the message body, and extracts the response sentence.

Input: network response message with encoded response text.

Terminal updates the chat UI by appending the response sentence as a new message bubble, optionally updating transaction displays such as balance fields, and renders the updated view on the display.

Output: visual presentation of the response sentence and updated state on the terminal screen.

### Step 19:

User observes the response and optionally initiates a new interaction.

User reads the displayed response, confirms the reported amounts or transaction statuses, and decides whether to issue another natural language request, which re-enters the flow at the initial steps.

Input: displayed response and updated account or transaction information as perceived by the user.

User, based on understanding and satisfaction, generates a new natural language utterance or ends the interaction.

Output: new user behavior, either termination of the session or a new natural language input to be processed by the system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional workflow and business application systems that accept user requests in natural language typically rely on static rule sets, fixed process definitions, and manually designed user interfaces. In such systems, a server usually performs simple keyword extraction and rigid routing of a request to a predetermined workflow, without deeply analyzing the semantic content of the user input or the emotional state of the user. As a result, the server cannot flexibly adapt process flows or response messages to the actual intent, context, or urgency conveyed in the user's input.

In addition, conventional systems generally separate natural language interfaces from back-end workflow engines and data stores. A natural language interface may provide a conversational front-end, but the underlying process execution remains hard-coded. Changes in business procedures, exception handling, or user-specific guidance often require manual reconfiguration by an administrator or developer. This leads to high maintenance cost, delays in deploying updated procedures, and a lack of responsiveness to evolving business rules or user needs.

Furthermore, existing systems that make use of generative AI models often employ such models only at the user interface layer, for example, to paraphrase user queries or produce generic responses. The generative AI output is rarely integrated into core process control, such as dynamically altering task execution conditions, reordering workflow steps, or adjusting notification content and timing based on real-time analysis of both structured business data and unstructured conversation history. This limited integration fails to leverage generative AI as a tool for improving computational efficiency and system-level decision making.

Another technical problem arises from the fragmentation of data across multiple components. User inputs, classification results, workflow states, and accumulated procedural know-how are often stored in disparate data structures and are not jointly exploited. As a consequence, the server cannot automatically generate high-quality prompt sentences that incorporate relevant business context, historical application data, and operational know-how. The lack of such context-rich prompt sentences reduces the accuracy and reliability of generative AI outputs, and prevents the system from systematically improving over time as more data is accumulated.

Moreover, conventional emotion analysis modules, if present at all, are typically isolated from workflow engines. The analysis of the user's emotional state is not reflected in process control decisions or response generation. For example, user frustration or urgency detected in text or voice input is not used to prioritize certain tasks, escalate specific cases, or adjust the tone and detail level of explanations. This results in a disjointed user experience and inefficient allocation of computational and human resources.

Accordingly, there is a need for an improved computer-implemented system in which a processor unifies natural language understanding, emotion analysis, workflow management, data storage control, and generative AI integration. There is a need for the server not only to classify and route application matters, but also to construct and utilize context-rich prompt sentences for a generative AI model, and to feed back the generated information into dynamic modification of workflow execution. By tightly coupling these components, the system can achieve improved processing efficiency, reduced manual configuration, enhanced adaptability of workflows, and more accurate and context-aware user guidance, thereby providing a concrete improvement in the functioning of the computer system itself.

The specific processing by the specific processing unit 290 of the data processing device 12 in Example 2 is realized by the following means.

The present invention provides a server comprising a processor configured to execute an interactive agent unit that receives application matters expressed in natural language from a user; an information processing unit that analyzes the natural language input of the application matters, converts the analyzed natural language input into structured text data, and classifies the application matters into business categories based on the structured text data; a process flow management unit that manages business processing procedures corresponding to the business categories and automatically starts and controls the business processing procedures; an information storage control unit that searches management information and application history information stored in a data storage device in association with processing by the process flow management unit, and stores and updates records including search results; an emotion analysis unit that analyzes text input and voice input of the user and specifies an emotional state of the user by using natural language processing techniques; an information generation unit that generates a prompt sentence based on business processing results obtained by the information processing unit and the process flow management unit, management information acquired by the information storage control unit, and contextual information including the natural language input of the user, transmits the prompt sentence to a generative AI model, and generates information necessary for a procedure by using generated information acquired from the generative AI model; a reporting unit that integrates the information generated by the information generation unit and the business processing results produced by the process flow management unit and notifies the user of integrated information via the interactive agent unit; and a business optimization unit that dynamically changes execution conditions, execution order, and notification contents of tasks in the process flow management unit based on the prompt sentence and the generated information generated by the information generation unit so as to optimize business processing. This enables the computer system to internally transform unstructured user input, accumulated operational data, and emotion analysis results into context-rich prompt sentences, to use a generative AI model as a core decision-support component, and to feed back the generated information into dynamic workflow control, thereby improving the efficiency, adaptability, and technical performance of the server in executing business processes.

The term “interactive agent unit” refers to a functional component executed by a processor that provides a conversational interface, receives user inputs expressed in natural language via text or voice, and returns responses to the user through an interactive communication channel.

The term “application matters” refers to requests, inquiries, or instructions submitted by a user to a system, including but not limited to business applications, approval requests, information queries, and operational procedures to be executed by the system.

The term “natural language input” refers to information expressed in a human language, such as text or speech, provided by a user to the system, and processed by the system without requiring a predefined command syntax or structured format.

The term “information processing unit” refers to a functional component executed by a processor that analyzes natural language input, converts the analyzed input into structured data, and classifies the content of the input into one or more business categories based on the structured data.

The term “structured text data” refers to data derived from natural language input that has been transformed into a predetermined format, such as key-value pairs, records, or objects, suitable for programmatic processing, classification, and storage.

The term “business categories” refers to classifications that indicate types of business-related processing, workflows, or procedures associated with corresponding application matters, such as categories for approvals, inquiries, reservations, or operational tasks.

The term “process flow management unit” refers to a functional component executed by a processor that manages definitions of business processing procedures, automatically initiates and controls execution of tasks in accordance with such procedures, and monitors the progress and status of workflow instances.

The term “business processing procedures” refers to ordered sets of operations, rules, and decision steps to be executed by a system for handling application matters, including task sequencing, conditional branching, approvals, notifications, and data updates.

The term “information storage control unit” refers to a functional component executed by a processor that controls access to a data storage device, performs searching, reading, writing, and updating of management information and history information, and maintains consistency of stored records.

The term “management information” refers to data related to configuration, rules, policies, user profiles, organizational structures, and other operational parameters that govern how a system performs business processing procedures.

The term “application history information” refers to data representing past application matters and their associated processing results, including timestamps, status changes, decisions, and related contextual information accumulated over time.

The term “data storage device” refers to a hardware or virtual component capable of persistently storing data, such as a database system, file system, or other non-transitory computer-readable storage medium used to maintain management information and history information.

The term “emotion analysis unit” refers to a functional component executed by a processor that analyzes user text input and voice input using natural language processing or signal processing techniques to estimate or classify an emotional state of the user.

The term “emotional state” refers to a condition or attribute inferred from user input, such as satisfaction, frustration, urgency, calmness, or other affective states that may influence how the system prioritizes tasks or formulates responses.

The term “information generation unit” refers to a functional component executed by a processor that constructs prompt sentences based on internal data and context, transmits the prompt sentences to a generative AI model, and processes generated outputs from the model to produce information necessary for business procedures.

The term “prompt sentence” refers to a text sequence or message constructed by the system that includes contextual information, such as application data, management information, and conversation history, and that is supplied as input to a generative AI model to elicit a desired generated output.

The term “generative AI model” refers to a computational model, such as a neural network-based language model, configured to receive a prompt sentence and generate new text or other content based on learned statistical patterns and semantic relationships.

The term “generated information” refers to output content produced by a generative AI model in response to a prompt sentence, including explanations, instructions, summaries, or other data that can be used by the system to support or refine business processing procedures.

The term “reporting unit” refers to a functional component executed by a processor that combines information generated by the information generation unit with business processing results, formats such combined information, and outputs it to the user via the interactive agent unit or other communication channels.

The term “business optimization unit” refers to a functional component executed by a processor that uses prompt sentences and generated information to dynamically modify execution conditions, execution order, and notification contents of tasks within business processing procedures to improve efficiency and adaptability of the system.

The term “execution conditions” refers to parameters, thresholds, or rules that determine when, how, or under what circumstances specific tasks in a business processing procedure are initiated, paused, skipped, or terminated.

The term “execution order” refers to the sequence in which tasks or operations within a business processing procedure are performed, including linear sequences, conditional branches, parallel branches, and reordered task flows.

The term “notification contents” refers to information included in messages or alerts that are sent to users or other components, such as status updates, instructions, explanations, or requests for additional input.

The term “contextual information” refers to data describing the situation surrounding an application matter, including user input history, system state, related management information, emotion analysis results, and prior workflow results, which is used when generating prompt sentences and responses.

The term “business processing results” refers to outcomes produced by execution of business processing procedures, including approval or rejection decisions, computed values, generated documents, and updated records stored in the data storage device.

In one embodiment, a server, a terminal, and a user cooperate to implement the invention. The server is realized by one or more computing machines, such as a rack-mount computer, a virtual machine in a cloud environment, or a cluster of such machines. The terminal is realized by a client device, such as a smartphone, a tablet, or a personal computer executing a web browser or a native application. The user operates the terminal to submit application matters and to receive responses from the server.

The server includes at least one processor, a main memory, a non-transitory storage device, and a network interface. The server executes an operating system and server-side software modules that implement an interactive agent unit, an information processing unit, a process flow management unit, an information storage control unit, an emotion analysis unit, an information generation unit, a reporting unit, and a business optimization unit. In one concrete implementation, the server executes a web application framework (for example, a generic web framework running on an application server), a relational database management system (for example, a generic SQL database), and a workflow engine (for example, a generic workflow orchestration engine). The server further accesses a generative AI model through an application programming interface exposed by a model serving environment.

The terminal executes a user interface program, such as a web browser displaying a web application or a native mobile application. The terminal transmits user inputs to the server over a network using a communication protocol such as HTTPS, and the terminal displays responses received from the server in the form of text messages, dialog windows, or notification banners. The terminal may also capture audio input from a microphone and convert the audio input into text by executing a speech recognition library prior to transmission to the server.

The user provides application matters and follow-up questions to the system by entering natural language through a text input field or by speaking into the terminal. For example, the user may type or dictate, in plain language, a request such as “I want to apply for paid leave from next Monday to Friday.” or “I plan to apply for reimbursement of my travel expenses for a business trip last week. What documents do I need?” The user then observes, on the terminal, detailed instructions and explanations generated by the server in response to these inputs.

The server executes the interactive agent unit to receive natural language input from the terminal. The interactive agent unit interprets incoming network messages, performs session management, and associates each user utterance with a conversation context. The interactive agent unit stores the raw natural language text in a structured data store, such as a table of utterances indexed by a session identifier and a timestamp, in the database managed by the information storage control unit. The interactive agent unit then forwards the text content and session context to the information processing unit and the emotion analysis unit.

The server executes the information processing unit to transform unstructured natural language input into structured text data suitable for machine processing. In one implementation, the server loads a natural language processing library, such as a generic tokenization and parsing toolkit, and applies lexical analysis, syntactic parsing, and semantic labeling to the text. The server uses a sequence of algorithms implemented in the information processing unit, including tokenization, part-of-speech tagging, and dependency parsing, to identify subject terms, action verbs, dates, amounts, and other relevant entities. The server then maps the extracted features into an internal data structure, for example, a record having fields such as “intent type”, “date range”, “amount_value”, “user_identifier”, and “business_category”.

In one embodiment, the server uses a neural network model in the information processing unit to determine an intent type and a business category. The server configures a transformer-based neural network model having multiple self-attention layers, feedforward layers, and layer normalization components. The server trains this model in advance using supervised learning on labeled request data. The server defines an objective function, such as cross-entropy loss over business category labels, and applies a gradient-based optimization algorithm to update the weights of the model. The server stores the trained model parameters in the non-transitory storage device and loads them into main memory for inference. During operation, the server encodes each user utterance as a sequence of token embeddings, passes the embeddings through the transformer layers, and obtains a probability distribution over business categories. The server then selects, as the classification result, the category having the highest probability and stores this category in the structured text data.

The server executes the process flow management unit to manage business processing procedures based on the business category. The server maintains, in the database, a set of workflow definitions, each definition specifying an ordered set of tasks, conditions, and decision points. Each workflow definition includes metadata describing dependencies between tasks and resource requirements. The process flow management unit executes a scheduling algorithm that resolves dependencies and allocates tasks to execution threads or external systems. For example, the server may schedule a task to query a user record, to evaluate a policy rule, or to generate an approval notification. By performing this scheduling algorithm internally, the server reduces latency and avoids unnecessary polling of external services, thereby improving processing speed.

The server executes the information storage control unit to retrieve and update management information and application history information. For example, the server may execute structured query language statements to obtain the user's remaining leave balance, organizational role, and prior application records. The information storage control unit uses indexing strategies, such as B-tree indexes on user identifiers and timestamps, to accelerate retrieval of relevant records. By combining multiple database operations into a single transaction, the information storage control unit reduces disk I/O overhead and ensures consistency of application state, which improves data management and reduces computational overhead associated with error recovery.

The server executes the emotion analysis unit to analyze the emotional state of the user from text or optionally from voice. For text input, the server extracts features such as word embeddings, punctuation patterns, and sentence length characteristics. For voice input, the server optionally extracts prosodic features, such as pitch, volume, and speech rate. The server passes these features into an emotion classification model, which may be a multi-layer neural network trained on labeled emotion data. The server computes, for each predefined emotion category, a score representing the likelihood that the user exhibits that emotion, and the server selects one or more dominant emotion labels. The server then stores the detected emotion labels and confidence scores in the database associated with the corresponding utterance. This enables subsequent components to adapt processing based on user emotion, for example, by prioritizing urgent requests or by selecting more detailed explanations for confused users.

The server executes the information generation unit to construct prompt sentences for the generative AI model. The server obtains, from the information storage control unit and the process flow management unit, various context data including: the structured text data derived from the current request, management information such as policies and rules, application history of the user, workflow execution results, and detected emotional state. The server then applies a template-based generation algorithm and rule-based selection of context segments to build a prompt sentence that includes only relevant and up-to-date data. By including, in a controlled manner, identifiers, dates, rule summaries, and current status values, the server prevents the generative AI model from hallucinating non-existent data and reduces the token length of the prompt, thereby decreasing computation time and communication load.

In one example, the server generates the following prompt sentence for the generative AI model after approving a leave request:
“You are an assistant for an internal HR leave management system.
Here is the processed application data:
   Employee name: Taro Yamada
   Employee ID: U12345
   Department: Sales
   Request type: Paid leave
   Requested period: 2026-02-02 (Monday) to 2026-02-06 (Friday)
   Result: Approved
   Remaining paid leave days after this request: 7
Please generate a clear and polite explanation in English that will be sent to the employee.
Your explanation must include:
1. A confirmation that the paid leave request has been approved.
2. The exact vacation period.
3. The remaining number of paid leave days.
4. Short instructions on what to do if the employee wants to change or cancel this leave.
Use a concise and friendly tone.”

In another example, the server generates the following prompt sentence to provide guidance before an application is submitted:
“You are an assistant for a corporate expense reimbursement system.
Here is the company's simplified reimbursement policy:
   Travel expenses must be claimed within 30 days after the trip.
   Receipts are required for transportation and accommodation.
   A travel report must be submitted for trips longer than 2 days.
The user's question is: ‘I plan to apply for reimbursement of my travel expenses for a business trip last week. What documents do I need?’
Based on the above policy, please generate a clear, step-by-step explanation of:
1. Which documents the user must prepare.
2. How to submit these documents in the system.
3. Any deadlines or important notes the user should be aware of”

The server transmits such prompt sentences to the generative AI model via a network interface. The generative AI model is implemented, for example, as a large-scale neural network having an encoder-decoder structure or a decoder-only transformer structure, with multiple attention heads and stacked layers. The model is trained on a large corpus using an objective function such as next-token prediction, and it is fine-tuned, in one embodiment, on domain-specific instructions and examples. The server invokes the model by sending the prompt sentence as input tokens, and the model generates output tokens according to an auto-regressive decoding algorithm. The server configures decoding parameters, such as a temperature parameter, a top-k or top-p sampling threshold, and a maximum token length, to balance diversity and determinism of the output.

The server processes the output of the generative AI model in the information generation unit. The server parses the generated text and, if necessary, splits the output into segments corresponding to distinct instructions or explanations. The server applies post-processing rules to remove redundant sentences, to correct formatting, and to filter content that may conflict with internal policies. The server then stores the resulting generated information in the database, referencing the corresponding application matter, workflow instance, and user identifier. By storing the generated information in this structured manner, the server can later reuse informative parts of the explanation as additional context in future prompt sentences, thereby improving accuracy and consistency over time.

The server executes the reporting unit to compose final messages to the user. The reporting unit retrieves the business processing results from the process flow management unit and the generated information from the information generation unit. The reporting unit applies formatting rules, converts internal codes into human-readable descriptions, and, when appropriate, adjusts the tone or level of detail based on the emotional state detected by the emotion analysis unit. The reporting unit transmits the composed message to the terminal via the interactive agent unit. The message may be delivered as a text block in a chat interface, an email notification, or a notification within a dashboard display.

The server executes the business optimization unit to adjust workflow execution based on prompt sentences and generated information. For example, when the generative AI model suggests that certain steps are unnecessary for a particular context, and when the suggestion satisfies predefined safety rules encoded in a rule base, the business optimization unit may modify the execution order by skipping or postponing specified tasks. In another example, when the generative AI model highlights missing data or potential conflicts, the business optimization unit may insert additional validation tasks before final approval. The business optimization unit represents workflows as directed graphs and applies graph transformation operations, such as node insertion, node removal, and edge redirection, based on machine-generated recommendations and rule-based constraints. This dynamic modification reduces the number of redundant tasks and shortens the path length of the workflow graph, producing measurable improvements in processing latency and resource utilization.

The server achieves technical effects beyond mere automation of human procedures. By using structured text data derived from natural language input, the server reduces ambiguity and enables precise classification, which eliminates many manual routing errors. By integrating an emotion analysis unit, the server can prioritize tasks and adjust message content in a way that reduces unnecessary communication cycles and re-submissions, which directly improves overall throughput. By constructing context-rich prompt sentences and feeding generative AI outputs back into workflow control, the server systematically reduces the number of interactions required to obtain complete and correct information from the user. This results in fewer database writes, reduced network round-trips, and lower computational load in subsequent processing stages.

The server also improves computer technology by implementing specific data structures and algorithms that optimize input-output behavior. For example, by generating prompt sentences that include only necessary fields selected through a relevance scoring algorithm, the server reduces the average prompt size supplied to the generative AI model. This leads to faster model inference and lower bandwidth usage between the server and the model serving environment. By indexing application history information based on business category and emotion labels, the server enables efficient retrieval of similar past cases to guide prompt construction and determine safe optimization actions, reducing the need for exhaustive searches.

The server implements non-conventional rules and procedures that differ from simple human reasoning. For instance, the server may compute a confidence measure for each suggested workflow modification based on a combination of generative AI likelihood scores, rule-based compatibility checks, and historical success rates recorded in the database. Only when this confidence measure exceeds a configured threshold does the business optimization unit commit to changing execution conditions or execution order. This machine-centric decision mechanism, relying on vectorized representations, probability distributions, and historical performance metrics, is fundamentally different from straightforward human decision-making and yields consistent, data-driven improvements in execution quality.

Alternative embodiments are also possible. In one variation, the server executes multiple generative AI models, each specialized for different business categories or languages, and the information generation unit selects an appropriate model based on user profile and request type. In another variation, the server deploys the generative AI model locally on-premises when data privacy constraints require internal processing, and the server uses a hardware accelerator, such as a generic graphics processing unit, to execute the neural network inference. In yet another variation, the server compresses and quantizes model weights to reduce memory consumption and latency, thereby further improving computational efficiency.

In another embodiment, the server adjusts learning parameters of one or more models in an online or periodic retraining process. The server may collect feedback information, such as user ratings of explanations or error corrections entered by administrators, and may update model weights using incremental gradient updates. The server may evaluate loss functions that combine accuracy of business category prediction, correctness of procedural steps, and user satisfaction scores. By iteratively minimizing such multi-component loss functions, the server improves model performance on domain-specific tasks and thus enhances the precision and reliability of the entire system.

In all these embodiments, the terminal remains relatively simple, handling primarily data input and display, while the server performs complex transformations, model inferences, database operations, and workflow optimizations. This division of labor allows the system to scale horizontally on the server side, where advanced computational resources can be deployed, and allows terminals with limited resources to benefit from advanced generative AI processing without executing heavy models locally.

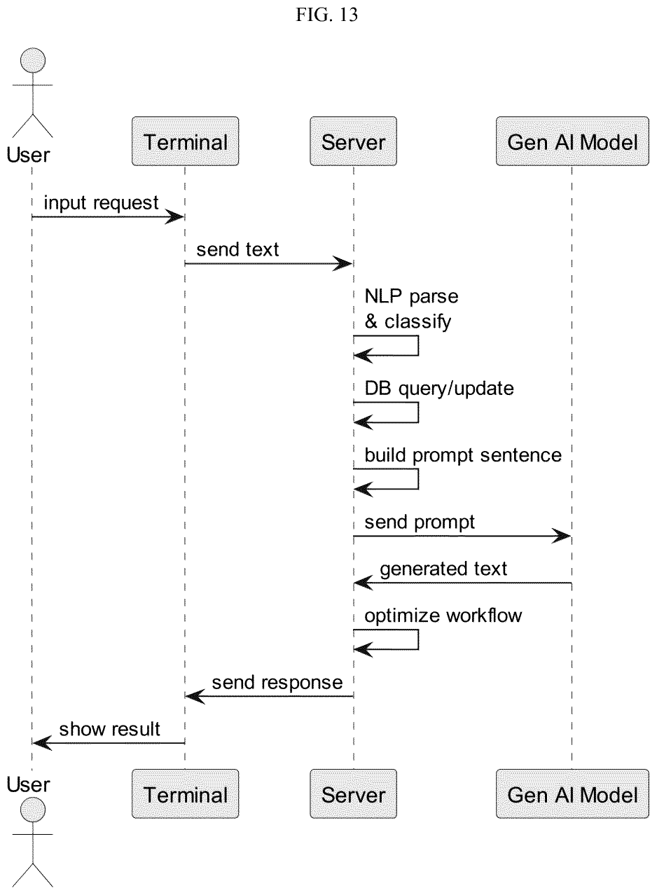

The following describes the processing flow using FIG. 13.

### Step 1:

The user operates the terminal and inputs an application matter in natural language.

The terminal receives, as input, raw user text or voice and converts voice input into text using a speech recognition module.

The terminal performs basic validation, such as checking that the text length is within a predefined range, and generates a request object including a user identifier, a session identifier, a timestamp, and the text.

The terminal outputs the request object and transmits it to the server via a network protocol such as HTTPS.

### Step 2:

The server receives the request object from the terminal.

The server takes, as input, the HTTP request containing the request object, and parses HTTP headers and the message body using a web server or application server.

The server validates the structure of the received JSON payload, extracts the user identifier, the session identifier, the timestamp, and the natural language text, and logs the raw input in a logging system.

The server outputs a normalized internal representation of the request, including the extracted text and metadata, and stores this representation in a temporary in-memory structure and optionally in a database table for utterances.

### Step 3:

The server executes the information processing unit to perform natural language preprocessing.

The server receives, as input, the normalized internal representation including the user's natural language text.

The server tokenizes the text into tokens, performs part-of-speech tagging, and applies dependency parsing using a natural language processing library or model.

The server extracts entities such as dates, periods, amounts, and named objects, and constructs structured text data containing fields like intent candidates, date ranges, and referenced objects.

The server outputs the structured text data as an internal record, for example a record with keys such as “candidate_intents”, “entities”, and “normalized_text”.

### Step 4:

The server executes an intent and category classification process.

The server takes, as input, the structured text data produced in Step 3.

The server encodes the normalized text as a sequence of token embeddings and feeds the embeddings to a trained neural network classifier, such as a transformer-based model, to compute a probability distribution over business categories.

The server selects the business category with the highest probability and calculates a confidence score; if the score is below a threshold, the server may request clarification from the user through the terminal.

The server combines the selected business category and the detected entities into an enriched structured record and outputs this record as classified application data.

### Step 5:

The server accesses stored management information and application history.

The server receives, as input, the classified application data including the user identifier and business category.

The server executes one or more database queries to retrieve user profile data, policy data, organizational information, and past application records from the data storage device.

The server merges the retrieved records with the classified application data, populating fields such as “remaining_quota”, “manager_id”, “policy_rules”, and “similar_past_cases”.

The server outputs consolidated context data that combines current request details with relevant management information and history information.

### Step 6:

The server determines a workflow definition and instantiates a workflow instance.

The server takes, as input, the consolidated context data including the business category and policy rules.

The server looks up a workflow definition associated with the business category in a workflow repository, loads the definition, and binds parameters such as user identifier, date range, and amount.

The server creates a workflow instance record, assigns it a unique workflow identifier, initializes task status flags, and stores the record in the database.

The server outputs a workflow instance descriptor containing the workflow identifier, initial task list, and execution parameters.

### Step 7:

The server executes workflow tasks under the process flow management unit.

The server receives, as input, the workflow instance descriptor.

The server runs a scheduling algorithm that selects one or more executable tasks based on dependency rules and current task statuses, and dispatches these tasks to worker modules.

The server performs business rule evaluations, such as comparing requested dates with remaining leave or checking policy constraints, and updates the workflow instance record with intermediate results and statuses.

The server outputs updated workflow state information, including completion status of tasks, intermediate decisions, and pending actions.

### Step 8:

The server executes the emotion analysis unit.

The server takes, as input, the user text and, when available, raw or preprocessed voice features associated with the same request or conversation.

The server extracts textual features such as word choice, punctuation, and sentiment indicators, and optionally extracts acoustic features such as pitch and intensity from voice data.

The server feeds these features into an emotion classification model, computes scores for multiple emotion categories, selects a primary emotion label, and assigns a confidence value.

The server outputs emotion analysis data that includes the primary emotion label, confidence score, and possibly secondary emotion labels, and stores this data linked to the user session.

### Step 9:

The server executes the information storage control unit to persist current state.

The server receives, as input, the updated workflow state information, the consolidated context data, and the emotion analysis data.

The server performs transaction-controlled writes to the database, storing or updating records in tables associated with applications, workflow instances, user context, and emotion annotations.

The server commits the transaction to ensure atomic persistence of changes, and updates indexes that support fast retrieval by user identifier, category, and status.

The server outputs a confirmation of successful storage and a reference handle that identifies the stored state for subsequent retrieval.

### Step 10:

The server executes the information generation unit to construct a prompt sentence for the generative AI model.

The server takes, as input, the consolidated context data, the workflow state information, the emotion analysis data, and the stored management information and history.

The server selects relevant data fields based on the business category and emotion state, such as current decision result, remaining quota, policy excerpts, and prior similar cases, and inserts them into one or more template structures.

The server assembles a prompt sentence in natural language that includes contextual details and explicit instructions to the generative AI model about output style, content, and constraints.

The server outputs the prompt sentence as a text string ready to be supplied to the generative AI model.

### Step 11:

The server calls the generative AI model and obtains generated information.

The server receives, as input, the prompt sentence produced in Step 10.

The server tokenizes the prompt sentence, sends the token sequence to the generative AI model via an application programming interface, and configures decoding parameters such as maximum length and sampling strategy.

The server receives a sequence of output tokens from the generative AI model, reconstructs them into a text response, and performs optional post-processing, such as removing disallowed phrases or correcting formatting.

The server outputs generated information, such as a detailed explanation of a decision or a step-by-step procedure, and stores this information in association with the application and workflow instance.

### Step 12:

The server executes the business optimization unit to adjust workflow behavior.

The server takes, as input, the prompt sentence, the generated information, and the current workflow state.

The server analyzes the generated information for indications that certain tasks can be skipped, reordered, or augmented, and evaluates these indications against predefined safety and policy rules.

The server computes a confidence score for each potential modification and, when the score exceeds a threshold and rules permit, updates the workflow instance descriptor by changing execution conditions, task order, or notification parameters.

The server outputs an optimized workflow state, reflecting any approved modifications, and persists these changes in the database.

### Step 13:

The server executes the reporting unit to compose a response to the user.

The server receives, as input, the generated information, the final or current workflow result, and the emotion analysis data.

The server merges status indicators (such as approved, rejected, or awaiting information) with explanatory text produced by the generative AI model and, when appropriate, adjusts language style (for example, level of detail or politeness) based on the detected emotional state.

The server formats the response into a message structure suitable for the communication channel, such as a chat message or an email body, and encapsulates it in a response object.

The server outputs the response object and sends it back to the terminal via the interactive agent unit.

### Step 14:

The terminal receives the response object from the server.

The terminal takes, as input, the response object containing status information and text content.

The terminal parses the response, extracts displayable text and status indicators, and updates the user interface to show the result and any instructions, for example within a chat bubble or a notification area.

The terminal stores the response locally if needed, for example in a local database or cache, and outputs the displayed information visually or audibly to the user.

### Step 15:

The user reviews the displayed information and optionally provides additional input.

The user reads or listens to the explanation and instructions presented by the terminal, and determines whether further clarification or additional actions are needed.

The user may input a follow-up question or a modification request in natural language, such as asking to change dates or requesting more details about required documents.

The user causes the terminal to send this new input, which becomes new input data for repeating Steps 1 and subsequent steps, enabling iterative refinement and further automated processing by the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional interactive systems that receive and process user applications suffer from several technical limitations in how they interpret natural language input, manage heterogeneous backend processes, and adapt to user state in real time.

First, typical dialog systems map user utterances to fixed intents and static workflows. Such systems generally rely on shallow pattern matching or limited natural language understanding and do not robustly transform free-form text or speech into rich structured data. As a result, downstream processing modules must either implement redundant parsing logic or operate on partially structured data, which increases CPU cycles, I/O operations, and error-handling overhead across the computing infrastructure.

Second, existing architectures often treat emotion analysis, business logic, and reporting as isolated components. Emotion analysis, if present, is usually bolted on as an auxiliary feature and is not integrated into the core control flow that determines processing priority, resource allocation, and workflow selection. Consequently, computing resources are not allocated according to user urgency or stress level, leading to inefficient task scheduling and increased latency for time-critical or high-friction sessions. The system cannot systematically adjust the order and nature of tasks based on dynamic emotional context, limiting its ability to optimize throughput and user-perceived responsiveness at the platform level.

Third, inventory monitoring and similar periodic backend tasks typically run as separate monitoring services that are decoupled from conversational interfaces and higher-level orchestration. This separation forces the operator to maintain multiple pipelines: one for monitoring and alerts, and another for dialog and application handling. Such fragmentation increases inter-process communication, complicates state management, and makes it difficult to implement unified prioritization strategies for both user-initiated requests and system-initiated alerts. The computing platform thus incurs additional synchronization and coordination overhead.

Fourth, many systems use generative AI models only as a cosmetic layer to generate natural language replies, without integrating the model into the core data processing pipeline. In such designs, the generative model is not used to standardize and optimize prompt sentences, to extract structured information, or to adapt messages based on emotion and business state. This underutilization results in duplicated rule-based code to construct explanations and procedures, increased maintenance burden, and missed opportunities to centralize complex text reasoning in a single, updatable model endpoint.

Fifth, conventional systems lack a unified knowledge management mechanism that treats dialog histories, structured application data, emotion signals, generated prompt sentences, and model responses as interrelated machine-readable knowledge. Without such an integrated store, it is difficult to automatically derive and update standard operating procedures, response templates, and reusable know-how. This leads to manual documentation processes, inconsistent workflows across deployments, and poor reusability of learned behavior when the system is replicated or provided to external organizations.

Collectively, these limitations manifest as a computer-technical problem: the computing environment, comprising servers, storage, and networks, is not organized to efficiently transform noisy, emotionally laden natural language input and backend state into optimized, prioritized, and explainable workflows. The result is increased computational complexity, higher latency, fragmented data paths, and difficulty in evolving and exporting the system's behavior as machine-readable know-how.

Accordingly, there is a need for a system architecture and processing method that (i) tightly integrates deep natural language processing, emotion analysis, and business rule execution, (ii) leverages a generative AI model through well-structured prompt sentences for both structured reasoning and message generation, (iii) unifies user-driven and monitoring-driven events into a common prioritization and scheduling framework, and (iv) continuously stores and reuses interaction and processing artifacts as structured knowledge. Such an arrangement should improve the way the computer itself allocates processing resources, manages workflows, and generates explanations, thereby technically enhancing the performance, flexibility, and maintainability of the overall information processing system.

The specific processing by the specific processing unit 290 of the data processing device 12 in Application Example 2 is realized by the following means.

The present invention provides a server comprising a processor configured to execute an interactive agent to receive natural language data transmitted from a communication terminal, to analyze the natural language data using a natural language processing technique to generate structured data including application type, period, quantity, and identifier, to determine an intention of application matters based on the structured data and to select and invoke at least one among a plurality of business processing units, to estimate emotion information including an emotion label and an emotion score from text and voice input of a user using at least one emotion analysis algorithm or service, to dynamically adjust at least one of processing priority, processing procedure, and processing content for the selected business processing units based on the emotion information and the structured data, to periodically acquire inventory information and compare inventory values with threshold values to identify target articles requiring replenishment, to generate a prompt sentence for input to a generative AI model based on at least the structured data, the emotion information, and a business processing result, to transmit the prompt sentence to the generative AI model and receive response data therefrom, to extract structured information and natural language messages from the response data and use the structured information to complement or correct the business processing result and use the natural language messages to generate explanatory, proposal, or instruction sentences, to transmit the generated messages via the interactive agent to the communication terminal, and to accumulate dialog history, structured data, emotion information, prompt sentences, and response data from the generative AI model as knowledge data and generate procedure information and response templates from the knowledge data as externally providable know-how. This enables the computing system to internally re-architect the processing of natural language user input, emotion-aware prioritization, inventory monitoring, and generative AI interaction into a unified, machine-executable pipeline, thereby reducing redundant parsing and rule logic, improving scheduling and resource allocation based on emotional urgency and backend state, centralizing complex text reasoning in a generative AI model through standardized prompt sentences, and continuously building a reusable knowledge base that enhances the performance, adaptability, and maintainability of the overall information processing platform.

The term “interactive agent” refers to a software or hardware function that conducts a dialog with a user by exchanging natural language messages, receives user input via a communication terminal, and returns system responses according to a predefined or learned dialog policy.

The term “natural language data” refers to data representing human language expressions, including at least text strings and speech-derived text, which are generated by a user and processed by the system for understanding and response generation.

The term “communication terminal” refers to an information processing device used by a user to interact with the system, including at least mobile devices, desktop devices, wearable devices, and any other network-connected user interface devices capable of sending and receiving data.

The term “natural language processing technique” refers to a computational method for analyzing natural language data, including at least tokenization, morphological analysis, part-of-speech tagging, syntactic parsing, semantic analysis, and entity extraction.

The term “structured data” refers to data that has been transformed from natural language data into a machine-readable format with defined fields, such as application type, period, quantity, identifier, and other attributes used for subsequent business processing.

The term “application matters” refers to user-originated requests, inquiries, notifications, or other actionable items submitted to the system for processing in a business or operational context.

The term “business processing unit” refers to a logical or physical component of the system that executes at least one specific business operation, such as approval processing, inventory update, scheduling, or notification, based on structured data.

The term “intention” refers to a logical representation of the purpose or goal underlying a user's natural language input, determined by analyzing the structured data to classify the type of application or request.

The term “emotion analysis algorithm” refers to a computational method that processes user input data, including at least text and voice features, to estimate an emotional state of the user, such as satisfaction, dissatisfaction, stress, or fatigue.

The term “emotion analysis service” refers to an external or internal service implemented on an information processing platform that receives user-related data and returns estimated emotion information based on that data.

The term “emotion information” refers to data including at least one emotion label and one or more emotion scores, representing an estimated emotional state of the user as determined by emotion analysis.

The term “emotion label” refers to a categorical identifier indicating a type of emotion, such as joy, anger, sadness, dissatisfaction, high stress, or fatigue.

The term “emotion score” refers to a numerical value assigned to an emotion label, representing the intensity or likelihood of the corresponding emotional state.

The term “processing priority” refers to an ordering parameter or weight that determines the relative urgency or execution order of multiple business processing tasks within the system.

The term “processing procedure” refers to a sequence of operations or steps executed by one or more business processing units to complete a business task based on structured data and additional context.

The term “processing content” refers to the specific operations, parameters, and rules applied during business processing, including which functions are executed and how data is transformed.

The term “business load” refers to the amount, type, or complexity of tasks assigned to a user, worker, or processing unit within a given period.

The term “processing order” refers to the sequence in which multiple tasks or application matters are executed by the system.

The term “storage device” refers to any data storage component, including at least main memory, secondary storage, and external storage systems, capable of storing user attribute information, application history information, inventory information, business progress information, and knowledge data.

The term “external information processing device” refers to a separate computing system or service accessible via a communication network, which exchanges data with the server for purposes such as data retrieval, update, or auxiliary processing.

The term “user attribute information” refers to data representing characteristics of a user, including at least user identification, role, preferences, and access rights.

The term “application history information” refers to data recording past application matters submitted by a user, including at least timestamps, types of applications, processing results, and related metadata.

The term “inventory information” refers to data representing the quantity and status of items or resources managed by the system, including at least current stock levels, threshold values, and update timestamps.

The term “business progress information” refers to data that indicates the state or progress of business operations, such as steps completed, tasks pending, and associated timing information.

The term “inventory amount” refers to a numerical value indicating the quantity of a particular target article or item currently available in stock.

The term “threshold value” refers to a predefined numerical limit used as a reference for determining whether an inventory amount or other metric is within an acceptable range or requires action.

The term “target article” refers to any managed item, product, or resource subject to inventory monitoring or replenishment decisions within the system.

The term “replenishment request information” refers to data generated by the system that indicates a need to increase the inventory amount of a target article, including at least an identifier of the article and a recommended replenishment action.

The term “generative AI model” refers to a machine learning-based model that generates data outputs, including at least text or structured information, in response to input data such as prompt sentences, and is capable of performing natural language generation and reasoning tasks.

The term “prompt sentence” refers to a natural language or semi-structured instruction or query generated by the server and provided as input to the generative AI model to specify a desired task or output format.

The term “prompt generation” refers to a process in which the server constructs and formats a prompt sentence based on internal state, structured data, emotion information, and business processing results for submission to a generative AI model.

The term “request data” refers to data formatted in accordance with a communication protocol, containing at least a prompt sentence and associated parameters, which is transmitted to a generative AI model or another external service.

The term “response data” refers to data returned from the generative AI model in reply to request data, including at least generated text and optionally structured information.

The term “generative AI linkage” refers to a functional connection between the server and a generative AI model, through which the server transmits prompt sentences and receives response data for use in business processing and message generation.

The term “structured information” refers to machine-readable data obtained from response data of a generative AI model, organized into predefined fields or formats suitable for direct use in business logic or database operations.

The term “natural language message” refers to a text output in human language generated by the generative AI model or derived therefrom, intended to be displayed or communicated to a user.

The term “explanatory sentence” refers to a natural language message that describes or clarifies a business processing result, decision, or status in a form understandable by a user.

The term “proposal sentence” refers to a natural language message that suggests at least one action, option, or recommendation to the user based on business processing results, emotion information, or system state.

The term “instruction sentence” refers to a natural language message that directs the user to perform at least one specific action or follow a described procedure.

The term “notification” refers to the act and data of transmitting a message from the server to a communication terminal, so that the message can be output to the user in at least one of a display format and a voice format.

The term “dialog history” refers to a record of exchanged messages and associated metadata between the interactive agent and the user over one or more sessions.

The term “knowledge data” refers to aggregated data including at least dialog history, structured data, emotion information, prompt sentences, and response data from a generative AI model, which is stored for reuse in improving business processing and response generation.

The term “procedure information” refers to an organized representation of steps or operations that describe how a particular business process or workflow is executed.

The term “response template” refers to a reusable pattern or schema for constructing natural language messages, which can be populated with variable data to generate specific responses.

The term “know-how information” refers to structured or semi-structured information derived from knowledge data, including at least procedure information and response templates, which can be provided to external organizations to reproduce or adapt the system's behavior.

The term “worker” refers to a human operator or staff member whose tasks or workload may be managed or adjusted by the system based on emotion information and business context.

The term “rest recommendation message” refers to a natural language message that suggests that a worker temporarily suspend tasks or take a break based on an estimated fatigue or stress state.

The term “summary of a business procedure” refers to a condensed natural language or structured description that outlines key steps and logic of a business process, derived from accumulated knowledge data.

The term “standard response procedure” refers to a canonical sequence of dialog and processing steps that are recommended by the system for handling a recurring type of application matter or user request.

The term “externally providable” refers to being suitable for export, sharing, or deployment to an external organization or system, for example as documentation, configuration data, or knowledge modules.

In one embodiment, a server, multiple terminals, and at least one generative AI model cooperate to implement the claimed system. The server includes at least one processor, a main memory, a non-volatile storage device, a network interface, and optionally one or more hardware accelerators such as graphics processing units or tensor processing units. The terminals include, for example, smartphones, tablet devices, desktop computers, or wearable devices such as smart glasses, each equipped with a display, input interface, and a communication interface. The generative AI model is hosted on the same server or on an external computing platform that is accessible via a communication network.

The server executes an operating system and middleware that provide process scheduling, memory management, and network communication. The server further executes an application layer program that implements an interactive agent, a natural language processing pipeline, an emotion analysis interface, business processing units, a prompt generation module, a generative AI linkage module, a knowledge management module, and supporting data access modules. The terminals execute client-side applications, such as a web browser, a chat application, or a dedicated native application, for sending natural language data and receiving messages from the server.

The server generates and maintains a set of data structures to support the processing. The server stores dialog state in a session table including at least a session identifier, a user identifier, a timestamp, and references to past utterances. The server stores natural language input as text strings associated with metadata such as language code and input modality. The server stores structured data as records with fields for application type, period, quantity, identifier, and additional attributes extracted from the natural language input. The server stores emotion information as records containing one or more emotion labels and corresponding numerical scores, along with timestamps and associations to specific utterances or sessions. The server stores inventory information as records containing item identifiers, inventory amounts, threshold values, and last update times. The server stores knowledge data as logs combining dialog history, structured data, emotion information, prompt sentences, and responses from the generative AI model.

The server uses a natural language processing technique implemented by a library or service such as a generic natural language processing API or a language processing library. The server performs tokenization by scanning the input text and splitting it into tokens based on character categories and language-dependent rules, stores token boundaries in an array, and assigns part-of-speech tags to each token using a statistical tagger represented by a trained parameter vector. The server then performs dependency parsing using a transition-based or graph-based parser, building a tree structure representing syntactic relations between tokens.

The server applies a named entity recognizer that uses a sequence labeling model to detect entities such as dates, item names, and user identifiers. The server maps combinations of syntactic roles and entity labels to high-level slots, thereby generating structured data that includes application type (for example, “vacation request” or “stock alert”), period (start and end date), quantity, and identifiers.

The server uses an emotion analysis algorithm that consumes both text features and acoustic features when available. For text, the server transforms the token sequence into numerical vectors using, for example, subword embeddings or contextual embeddings. For audio, the server segments the waveform into frames, performs a short-time Fourier transform to obtain spectrogram representations, and extracts features such as pitch, energy, and spectral centroid. The server concatenates or otherwise fuses these features and inputs them into a neural network-based classifier. In one embodiment, the neural network comprises an embedding layer, multiple transformer or recurrent layers for capturing temporal and contextual dependencies, and a final fully connected layer that outputs scores for a set of emotion categories. The server computes an emotion score for each category by applying a softmax function to the network output and selects one or more emotion labels based on maximum or thresholded scores. The server records these emotion labels and scores as emotion information.

The server adjusts internal scheduling parameters based on the emotion information. The server maintains a priority queue for business tasks, where each task is associated with a base priority determined by application type and a dynamic adjustment determined by emotion scores. The server calculates, for example, an adjusted priority as a weighted sum of base priority and emotion-derived values, where high stress or dissatisfaction labels increase the weight. The server inserts tasks into the queue based on this adjusted priority. As a result, the server allocates processor time and I/O bandwidth preferentially to tasks associated with urgent or high-friction sessions, thereby reducing latency for those tasks and improving overall throughput by aligning computational resources with user urgency.

The server performs inventory monitoring by periodically sending queries to a storage system or external inventory management module. The server retrieves a list of items and their current inventory amounts, writes them into inventory tables, and compares each inventory amount with a stored threshold value. The server computes a difference between the threshold and the current amount and marks any item whose amount falls below the threshold. The server aggregates these items into a list of target articles requiring replenishment and generates replenishment request information including item identifiers, current amounts, threshold values, and recommended replenishment quantities. The server thereby reduces repeated ad hoc checks and centralizes inventory state, which lowers redundant network traffic and the computational cost of repeated partial queries.

The server uses a generative AI model that is implemented as a large-scale neural network. In one embodiment, the generative AI model comprises an input embedding layer, multiple transformer blocks each including multi-head self-attention and position-wise feed-forward networks, and an output projection layer that maps hidden states to a token vocabulary. The generative AI model is trained on a large corpus of text data together with task-specific fine-tuning data. During training, the server or an external training platform minimizes a loss function, such as cross-entropy between predicted and target tokens, using gradient-based optimization. The weights of the model are updated by applying backpropagation through time and an optimization algorithm such as stochastic gradient descent or adaptive moment estimation. The training may utilize data augmentation methods such as synonym replacement or sentence reordering to enhance robustness.

The server interacts with the generative AI model by constructing prompt sentences that encode the server's current state and desired outputs. The server implements a prompt generation module that assembles text segments from structured data fields, emotion information, and recent dialog context. For example, when analyzing a vacation request, the server generates a prompt sentence such as:

“Analyze the following vacation request and return a JSON-like object with fields {employee_id, start_date, end_date, days requested, decision, reason}. Employee ID: 12345. Requested vacation: from 2024-03-01 to 2024-03-03. The user is feeling tired according to emotion analysis.”

When generating user-facing messages, the server generates a prompt sentence such as: “Generate a polite and supportive message in English to inform the user that their vacation request from 2024-03-01 to 2024-03-03 for employee 12345 has been approved. The user is tired, so please add a short encouragement.”

When performing inventory monitoring, the server generates a prompt sentence such as:

“Generate a concise notification to store staff about low inventory. Product name: Product B. Current stock: 3 units. Threshold: 5 units. Ask them to replenish the inventory.”

When providing worker support based on emotion analysis, the server generates a prompt sentence such as:

“A worker has shown increasing signs of stress over the last 3 hours. Propose a short, supportive message encouraging them to take a break, in polite English.”

The server formats these prompt sentences as part of request data that conforms to a communication protocol, including model parameters such as temperature and maximum output length, and transmits the request data through an application programming interface of the generative AI model. The server receives response data, parses it, and extracts either structured information or natural language messages. By centralizing complex text reasoning and message composition in the generative AI model via standardized prompt sentences, the server replaces numerous bespoke rule-based templates and conditional branches. This structural consolidation reduces code complexity, facilitates model-based updates without rewriting business rules, and improves consistency and accuracy of explanations and guidance messages.

The server uses the structured information returned by the generative AI model to complement or correct business processing results. For example, if the generative AI model suggests a number of vacation days or identifies boundary conditions that might have been overlooked by a rule engine, the server cross-checks these suggestions against its databases and integrates them into final decision records. The server thereby leverages the model's generalized language reasoning to detect exceptional patterns in text-based requests which conventional deterministic rules may not cover, resulting in fewer misinterpretations and lower error rates.

The server uses the natural language messages returned by the generative AI model to generate explanatory sentences, proposal sentences, and instruction sentences. The server stores these messages in result objects along with references to the underlying business decisions and emotion states. The server transmits these messages to terminals through a messaging protocol implemented by, for example, a web application framework or a chat platform interface. The terminals display the messages as text, notifications, or speech output, depending on terminal capabilities.

The server accumulates knowledge data by logging each dialogue pair of user input and system response, the structured data used for processing, the emotion information, the prompt sentences, and the corresponding generative AI outputs. The server periodically or on request uses this knowledge data to derive procedure information and response templates. For example, the server generates prompt sentences such as:

“Using the following log excerpts, summarize the standard operating procedure for handling vacation requests, including common user questions and recommended responses.”

The server then receives a narrative or structured description of the procedure from the generative AI model and stores it as business know-how. The server can export such know-how to external organizations as documents or as configuration files that can be loaded into other systems. By generating and managing this knowledge in a machine-readable form, the server allows other deployments to reproduce the same behavior with reduced configuration effort.

The server achieves a technical improvement over conventional architectures by designing the data flow and module interactions to exploit emotion-aware prioritization and generative model reasoning at low-level scheduling and resource allocation layers, rather than merely at the user interface layer. The server's use of structured data, emotion scores, and inventory thresholds as explicit numeric control parameters enables the scheduler to compute well-defined priority values instead of relying on static first-in-first-out ordering. The server thereby reduces average response time for critical sessions and prevents resource starvation for long-running tasks. The integration of inventory monitoring with conversational processing avoids multiple redundant monitoring pipelines and reduces synchronization overhead between separate services.

The server also improves the efficiency and quality of data management by unifying application matters, emotion information, inventory data, and generative AI artifacts into a shared schema. This design avoids fragmented storage across unrelated tables and lowers the number of data transformation steps required for cross-cutting analytics. As a result, the server can perform more accurate and timely consistency checks and can compute statistics needed to tune prompt sentences or adjust model parameters without exporting and re-importing data across different systems.

The server improves computational efficiency of natural language interpretation by delegating high-variability tasks, such as free-form explanation or summarization, to the generative AI model while restricting deterministic, high-throughput tasks, such as date arithmetic and threshold comparison, to traditional algorithms optimized in the server. By carefully partitioning responsibilities, the system avoids overloading the generative AI model with simple numerical tasks and limits the server-side rule engine to scenarios where explicit conditions are superior. This hybrid allocation reduces unnecessary model invocations, thereby lowering latency and communication load between the server and the generative AI platform.

The server uses a non-traditional processing sequence in which emotion analysis not only influences user messaging but directly modifies low-level priority values and branch conditions in the business processing flow. In contrast to human operators, who may subjectively adjust workload based on perceived emotion, the server computes deterministic adjustments based on learned emotion scores and predefined mappings, for example a function that increases priority proportionally to a dissatisfaction score above a threshold. This non-conventional rule set allows the server to consistently allocate resources based on quantifiable emotional signals, a behavior that cannot be realized by simple human task ordering or generic automation.

The server can be implemented in alternative configurations. In one variation, the generative AI model is hosted on the same hardware platform as the server application, using a local neural network inference engine accelerated by a graphics processing unit. In another variation, the generative AI model resides on a remote inference platform; the server uses an encrypted communication channel to send prompt sentences and receive responses. In yet another variation, the emotion analysis is performed entirely locally using a compact neural network trained for a limited set of emotions, while structured text reasoning uses an external larger generative AI model.

The server can adjust internal algorithmic parameters, such as the weighting of emotion scores in the priority calculation or the selection of inventory thresholds, on the basis of historical performance data stored in the knowledge base. The server thereby adapts its own control logic over time without requiring source-code changes, improving performance metrics such as processing latency, accuracy of intent classification, and correctness of inventory alerts.

The terminals support the server's technical behavior by capturing input signals such as speech and images using physical microphones and cameras, and by rendering output messages on physical displays or speakers. In the case of smart glasses, the terminal presents generative AI-derived suggestions to a worker in real time while the worker interacts with a customer or performs physical tasks, such as replenishing stock. The terminals thus serve as interfaces through which the server's improved processing architecture directly influences real-world activities, for example by accelerating stock replenishment when the server detects low inventory and by mitigating worker fatigue when the server recommends breaks based on emotion analysis.

The user interacts with the system by submitting application matters in natural language via the terminals and by responding to system prompts. The user's behavior, combined with signals from sensors attached to the terminals, generates the raw data on which the server performs its structured analyses, scheduling adjustments, and generative AI interactions. The user thereby participates in the formation of the knowledge data that the server uses to refine its internal rules and to generate externally providable know-how.

Through these interrelated components and data flows, the server, the terminals, and the generative AI model implement the claimed system in a manner that goes beyond merely automating an existing human workflow. The described embodiments improve technological aspects of natural language understanding, scheduling, data management, and model integration inside the computing system, and these improvements yield measurable effects such as faster processing of critical sessions, more accurate interpretation of complex user requests, reduced error rates in inventory alerts, and lower communication and computational overhead in maintaining and evolving the platform.

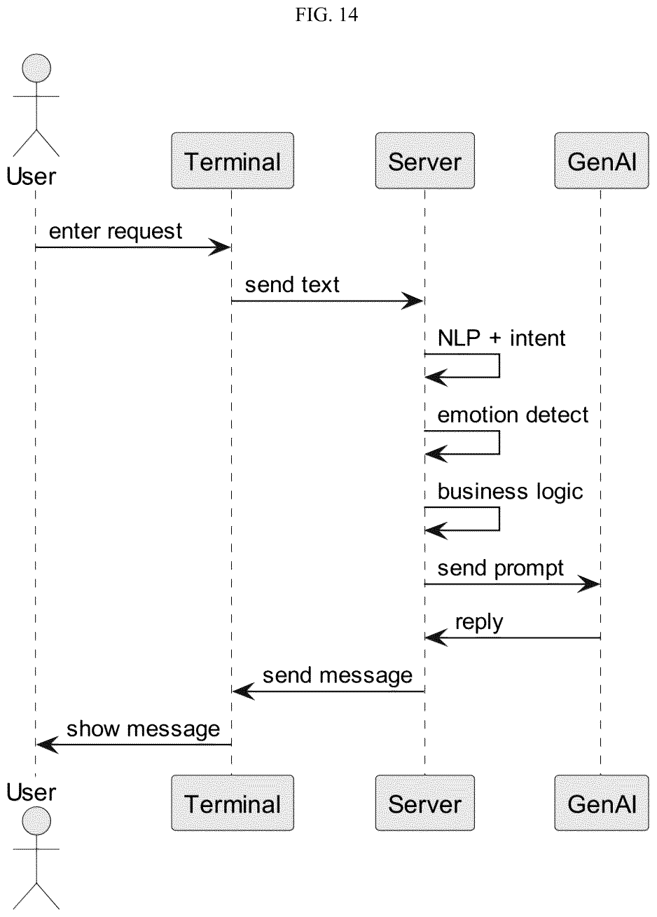

The following describes the processing flow using FIG. 14.

### Step 1:

User operates the terminal to input an application matter.

User opens a chat interface or web form on the terminal and enters natural language text, such as “I want to apply for vacation from March 1 to March 3” or “The stock of Product B is almost gone,” and optionally speaks into a microphone.

Input: raw user utterance (text and/or audio) plus implicit context such as time and user identity.

Output: user input captured by the terminal as text and metadata.

### Step 2:

Terminal converts the raw input into a request payload.

Terminal performs speech-to-text conversion for audio, attaches user ID, device ID, timestamp, and session ID, and encodes the text and metadata into a structured payload, for example a JSON object.

Input: raw text or audio from the user.

Data processing: terminal invokes a speech recognition component to transform audio frames into text, then aggregates the text with metadata into a data structure.

Output: structured request payload transmitted toward the server over a network connection.

### Step 3:

Server receives and authenticates the request payload.

Server accepts the payload via a network interface, verifies authentication tokens, associates the request with a session record, and discards or flags malformed or unauthorized payloads.

Input: structured request payload from the terminal.

Data processing: server validates token signatures, checks timestamps and user IDs, and updates a session table.

Output: validated request object stored in memory and linked to an active user session.

### Step 4:

Server executes the interactive agent to handle the user input.

Server passes the validated text to an interactive agent module which maintains dialog state, determines whether the user is starting a new request or continuing an existing one, and updates internal state variables.

Input: validated request object containing text and session identifiers.

Data processing: server looks up session context, merges the new text into a dialog history, and sets flags indicating current dialog phase.

Output: dialog context object including current utterance, past utterances, and session state.

### Step 5:

Server performs natural language parsing and entity extraction.

Server applies a natural language processing pipeline to the text, splitting it into tokens, assigning part-of-speech tags, detecting entities such as dates, quantities, and item names, and building a dependency structure.

Input: dialog context object with current text.

Data processing: server runs tokenization to produce a token list, applies statistical or neural taggers to assign labels, and applies named entity recognition to map token spans to semantic categories; server then groups related entities (for example, “March 1 to March 3” as a period).

Output: parsed representation and a set of extracted entities associated with the utterance.

### Step 6:

Server generates structured data representing the application matter.

Server maps the extracted entities and syntactic roles into defined fields such as application type, period, quantity, and identifier, and stores them as structured records.

Input: parsed representation and extracted entities.

Data processing: server applies mapping rules or classifiers to infer application type (for example, “vacation request,” “inventory alert”), computes normalized dates, converts textual quantities to numbers, and associates identifiers with user profiles.

Output: structured data object describing the application matter.

### Step 7:

Server determines the user's intention and selects a business processing unit.

Server interprets the structured data to classify the underlying intention, then consults a routing table to choose at least one appropriate business processing unit, such as a vacation management unit or inventory management unit.

Input: structured data object.

Data processing: server evaluates classification scores, compares them to thresholds, and selects the intention class; server then uses predefined mappings to resolve the class to a module identifier.

Output: routing decision and a combined object containing structured data and the identifier of the selected business processing unit.

### Step 8:

Server estimates the user's emotional state from text (and optionally from voice).

Server extracts textual features (such as token embeddings) and, when available, acoustic features from the utterance, feeds them into an emotion classification network, and obtains emotion labels and scores.

Input: raw text, optional audio features, and dialog context.

Data processing: server encodes text into numerical vectors, processes them through a neural network with multiple layers, computes logits for each emotion category, applies a softmax function to obtain probabilities, and selects labels with probabilities above a threshold.

Output: emotion information including at least one emotion label and an associated score.

### Step 9:

Server records the emotion information and updates the session.

Server attaches the emotion information to the current session record, storing it in an emotion table and linking it to the corresponding utterance.

Input: emotion information and session identifier.

Data processing: server inserts or updates a database row, computes running averages or trends of emotion scores for the session, and updates session-level emotion state.

Output: updated session state with stored emotion history.

### Step 10:

Server computes a processing priority based on emotion and application type.

Server combines a base priority value determined by application type with an adjustment term derived from emotion scores to obtain an overall priority measure for this task.

Input: structured data, emotion information, and business rules for priority.

Data processing: server computes a weighted sum or other function of base priority and emotion score, clamps the result within valid bounds, and assigns it to the task.

Output: task descriptor that includes a computed processing priority.

### Step 11:

Server enqueues the task in a priority queue for business processing.

Server inserts the task descriptor into a scheduler-managed priority queue, where tasks with higher priority are processed before lower-priority tasks.

Input: task descriptor with priority and target business processing unit.

Data processing: server performs a heap insertion or similar operation to maintain queue ordering by priority value.

Output: updated priority queue containing the new task.

### Step 12:

Server retrieves and updates domain data from storage systems.

Server fetches relevant records, such as remaining vacation days, past applications, or current inventory amounts, from a storage device or external system and, if necessary, updates them.

Input: structured data and identifiers (for example, employee ID, product ID).

Data processing: server issues database queries, joins related tables, performs simple arithmetic (for example, subtracting requested days from remaining days) or checks inventory amounts against thresholds, and prepares a working dataset for the business processing unit.

Output: domain-specific dataset for the business processing unit.

### Step 13:

Server executes the selected business processing unit.

Server invokes business logic corresponding to the selected unit to perform operations such as determining whether a vacation request is approvable or whether an inventory level has fallen below threshold.

Input: domain-specific dataset, structured data, and task descriptor.

Data processing: server applies rule sets, constraint checks, and calculations (for example, verifying no date conflicts, checking inventory differences) to derive a preliminary business processing result such as “approved,” “rejected,” or “replenishment required.”

Output: preliminary business processing result object.

### Step 14:

Server periodically acquires inventory information and identifies low-stock items.

Server runs a monitoring routine that collects current inventory amounts for each item, stores them in inventory tables, and compares them to threshold values to identify items requiring replenishment.

Input: inventory records from storage or an external system.

Data processing: server iterates over items, calculates the difference between threshold and current amount, and selects items where the current amount is below the threshold.

Output: list of low-stock items and corresponding replenishment request information.

### Step 15:

Server prepares context for a prompt sentence to a generative AI model.

Server aggregates structured data, emotion information, preliminary business results, and relevant historical context into a context object used by a prompt generation module.

Input: structured data, emotion information, business processing result, and session context.

Data processing: server serializes these elements into canonical text fragments or key-value pairs, resolves references (for example, mapping IDs to human-readable names), and orders them according to a prompt template.

Output: assembled context ready for prompt sentence construction.

### Step 16:

Server generates a prompt sentence for the generative AI model.

Server constructs a natural language prompt sentence that describes the task to be performed by the generative AI model, such as analysis, message generation, or procedure summarization.

Input: context object with structured fields and emotion state.

Data processing: server substitutes context values into a prompt template and concatenates segments into a coherent instruction, for example:

“Generate a polite and supportive message in English to inform the user that their vacation request from 2024-03-01 to 2024-03-03 for employee 12345 has been approved. The user is tired, so please add a short encouragement.”

Output: prompt sentence text for submission to the generative AI model.

### Step 17:

Server formats and sends the prompt sentence to the generative AI model.

Server wraps the prompt sentence and model parameters into a request object that conforms to an external API specification and transmits it via a network interface.

Input: prompt sentence and generation parameters such as temperature and maximum length.

Data processing: server encodes the text into a network-ready form, sets HTTP headers and authentication fields, and sends an API request to the generative AI endpoint.

Output: outbound request to the generative AI model and a pending call awaiting response.

### Step 18:

Server receives and parses the response data from the generative AI model.

Server obtains the response payload, extracts the generated text and, when present, structured content such as JSON-like segments, and separates them into internal fields.

Input: response data from the generative AI model.

Data processing: server decodes the payload, strips protocol metadata, parses any embedded structured segments, and cleans the textual content by removing control characters or extraneous delimiters.

Output: parsed generative AI output including natural language message(s) and optional structured information.

### Step 19:

Server refines the business processing result using structured information from the generative AI model.

Server incorporates any additional fields or corrections suggested by the generative AI model into the preliminary business result, subject to consistency checks against stored data and rules.

Input: preliminary business result and structured information from the generative AI output.

Data processing: server compares model-suggested values with existing database values and rule constraints, resolves conflicts (for example, preferring policy limits over model suggestions), and updates the result object when the suggestions are valid.

Output: final business processing result object.

### Step 20:

Server generates user-facing messages from the generative AI output.

Server selects or combines natural language messages returned by the generative AI model, possibly adding system-generated phrases such as identifiers or reference numbers, to build explanatory, proposal, and instruction sentences.

Input: generative AI messages, final business result, and user-specific preferences.

Data processing: server appends contextual details, applies formatting rules, and ensures that the resulting text adheres to language and tone policies; server may also split long messages into segments for display.

Output: finalized message text for delivery to the user.

### Step 21:

Server logs interaction artifacts into the knowledge base.

Server stores the dialog history, structured data, emotion information, prompt sentence, and generative AI response text as a single knowledge record linked to the session and application matter.

Input: all relevant artifacts from the completed task.

Data processing: server normalizes data into a defined schema, removes or masks sensitive fields as required, and writes the record to persistent storage with appropriate indices.

Output: updated knowledge data store containing a new reusable record.

### Step 22:

Server prepares notification payloads and chooses delivery channels.

Server retrieves user delivery preferences, selects an appropriate channel such as in-app chat, messaging service, or email, and constructs a channel-specific payload containing the message text.

Input: finalized message text, user identifiers, and channel preferences.

Data processing: server maps generic message fields to channel-specific parameters (for example, recipient ID, message type), and generates one or more payload objects.

Output: one or more notification payloads ready for transmission.

### Step 23:

Server sends notification payloads to the terminal.

Server transmits the payloads over network interfaces to the corresponding terminal or messaging platform, handling retries or error responses if needed.

Input: channel-specific notification payloads.

Data processing: server opens or reuses connections, issues API calls, processes status codes, and logs delivery attempts.

Output: outbound notification messages delivered to terminal-side services.

### Step 24:

Terminal receives and renders the notification for the user.

Terminal accepts the incoming notification, extracts the message text, and displays it in a user interface component or converts it to speech output.

Input: notification message from the server or from a messaging platform.

Data processing: terminal decodes message payloads, inserts them into the local chat or notification view, possibly triggers a sound or vibration alert, and updates local state.

Output: visible or audible feedback to the user containing the system's response and any instructions.

### Step 25:

User observes the response and may initiate follow-up interaction.

User reads or hears the message, confirms the result (for example, that a vacation request has been approved or that an inventory warning has been issued), and may decide to send further input to modify, cancel, or acknowledge the action.

Input: displayed or spoken message content.

Data processing: user mentally interprets the information and may formulate a new natural language utterance.

Output: new user input that is again captured by the terminal, leading back to the earlier steps in the processing flow.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

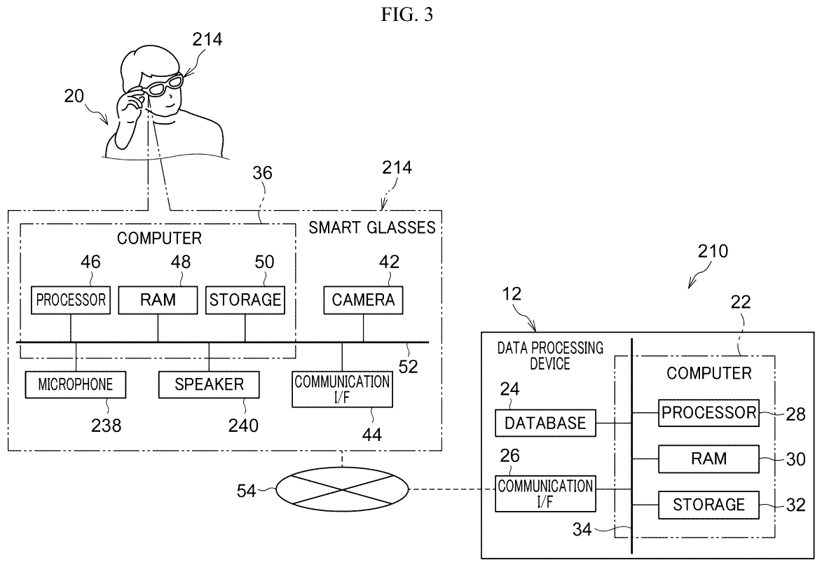

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

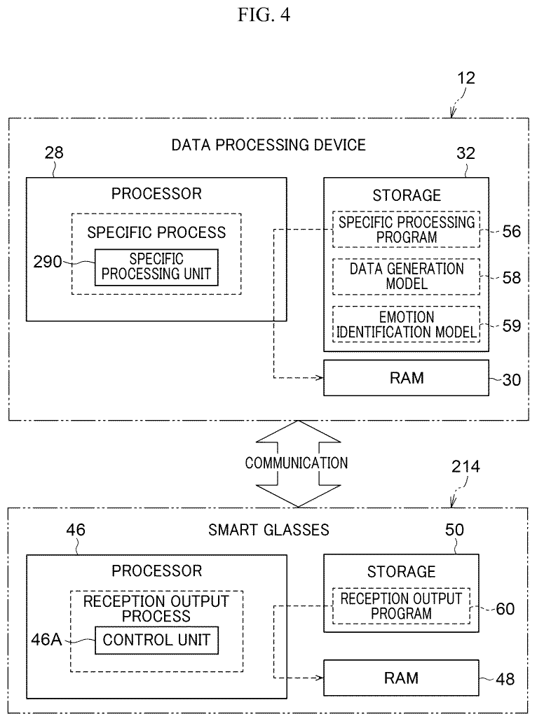

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

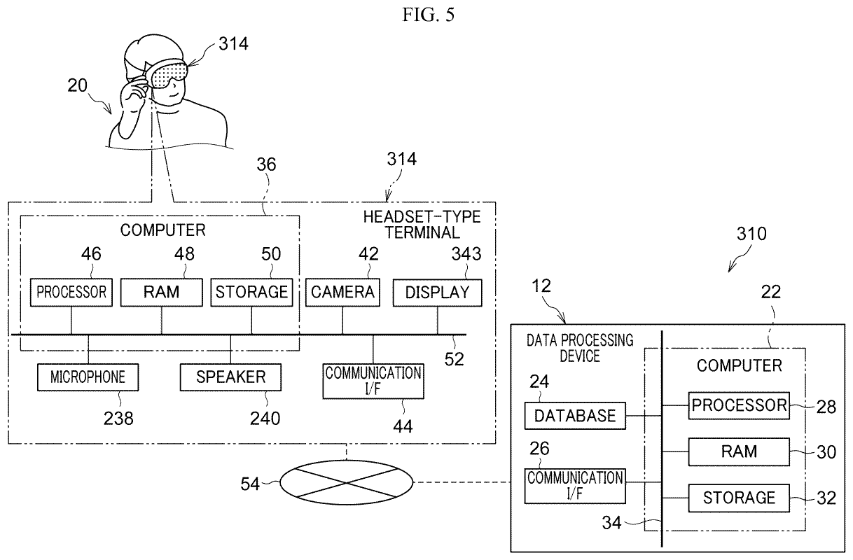

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

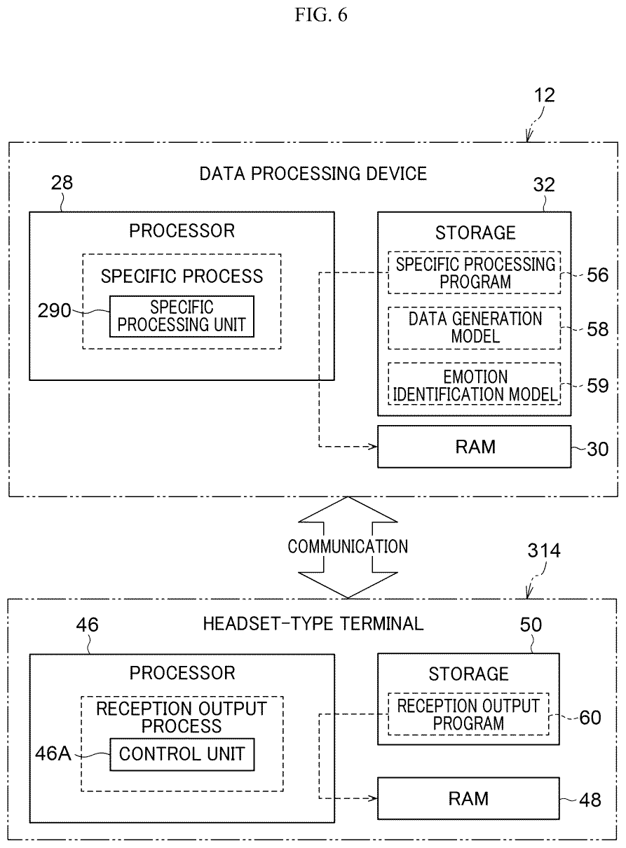

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

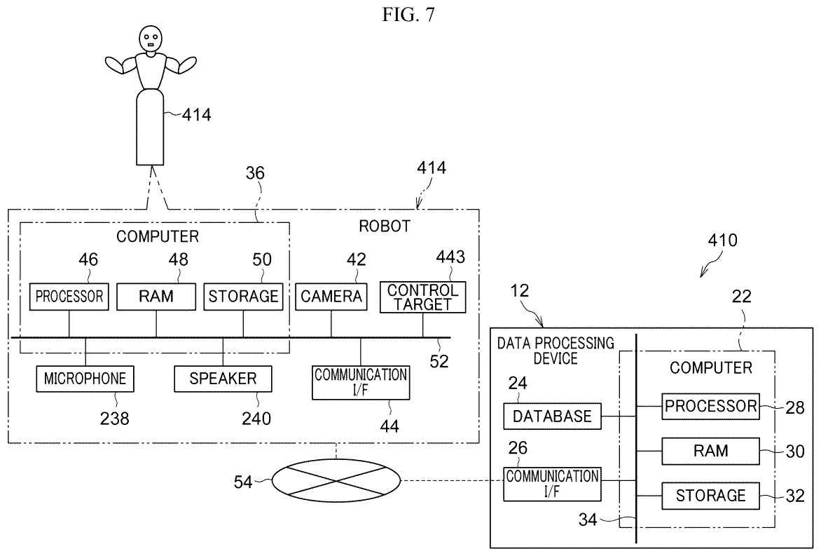

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

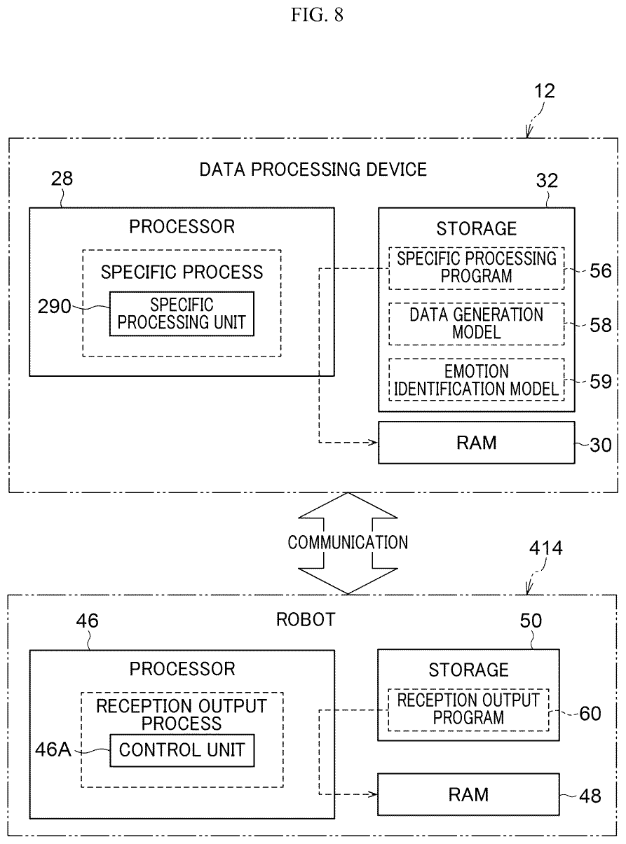

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

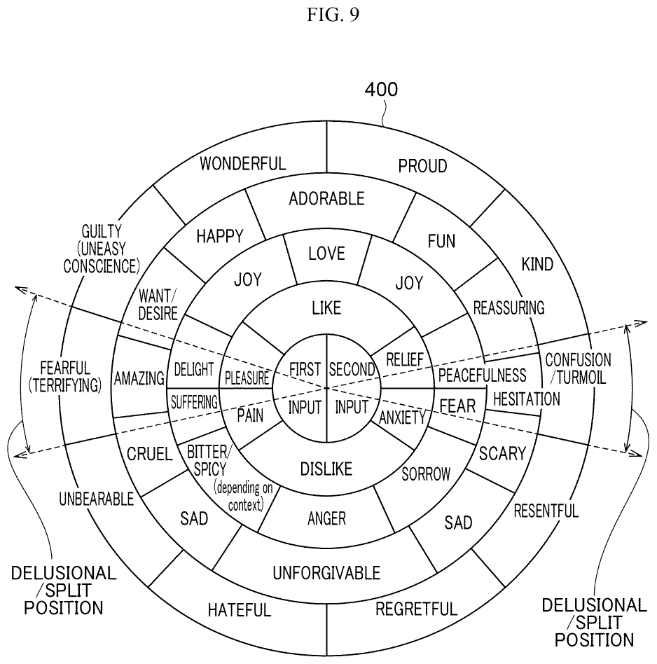

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

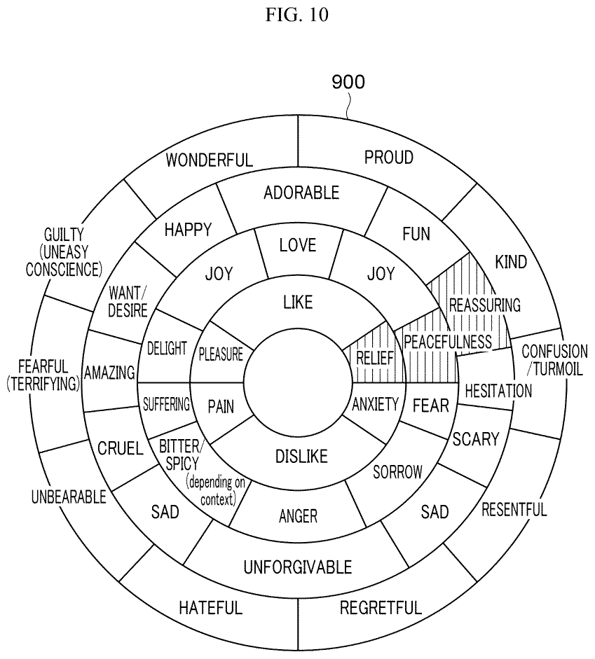

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive input information expressed in natural language from a user via a communication terminal,
obtain the input information as character information, convert the character information into a structured data format, and store the structured data,
analyze the structured data by using a natural language processing technique to identify a user intent and missing items of required information,
acquire, from a storage region, business process definition information that manages a business process corresponding to the user intent, and distribute the input information to the corresponding business process on the basis of an analysis result,
generate context information for input to a generative artificial intelligence model on the basis of the business process definition information and the missing items of required information,
execute the generative artificial intelligence model by using the context information and cause the generative artificial intelligence model to generate a prompt sentence for acquiring the missing items,
structure the generated prompt sentence as message information and transmit the message information to the communication terminal so that the prompt sentence is presented to the user,
receive, again, additional input information expressed in natural language from the user in response to the prompt sentence, extract the required information by using the natural language processing technique, and store the required information as business data for progressing the business process, and
complete the business process on the basis of the stored business data and report a completion result to the communication terminal.

### (Supplementary 2)

The system according to supplementary 1,
wherein the processor is configured to
acquire, from the business process definition information corresponding to the user intent identified by the natural language processing technique, a plurality of parameters required for the business process, determine insufficient parameters by comparing the plurality of required parameters with parameters extracted from the input information expressed in natural language from the user, and control the context information so that the generative artificial intelligence model generates the prompt sentence for acquiring only the insufficient parameters.

### (Supplementary 3)

The system according to supplementary 1,
wherein the processor is configured to
add, to the context information, history information including a progress status of the business process and the stored business data, cause the generative artificial intelligence model to generate, on the basis of the history information, a confirmation prompt sentence or a correction instruction prompt sentence, and update a state of the business process in accordance with a response content of the user to the prompt sentence.

### Application Example 1

### (Supplementary 1)

A system comprising a processor,
wherein the processor is configured to
receive, via a terminal, application matters and other requests expressed in natural language from a user by using an interactive agent unit,
analyze the received natural language input as character data by using a natural language processing unit that performs at least morphological analysis, syntactic analysis, intent classification, and element extraction to identify an application content, a transaction type, and transaction conditions,
distribute, by using a distribution unit, the analyzed natural language input to one or more business processing units and one or more electronic transaction processing units based on the identified application content and the identified transaction type,
generate, by using a prompt generation unit, a prompt sentence as an internal instruction sentence that explicitly describes contents and conditions of processing, the prompt generation unit being configured to call a generative AI model implemented as an external service or an internal process based on the natural language input and on intent information and element information obtained by the natural language processing unit,
interpret, by using the business processing unit, the generated prompt sentence and execute, in accordance with a processing target, reference conditions, transaction conditions, and verification conditions described in the prompt sentence, at least one of search processing, update processing, and record processing with respect to a data storage region,
execute, by using the electronic transaction processing unit, inquiry processing regarding transaction information, payment information, and account information associated with user identification information, and execute electronic transaction processing including at least balance inquiry, payment amount calculation, and transfer processing based on the prompt sentence,
obtain, by using a reporting unit, processing results from the business processing unit and the electronic transaction processing unit as structured data, and generate a natural language response sentence based on the structured data by using at least one of the generative AI model and a template-based sentence generation process, and present the generated response sentence to the user via the interactive agent unit, and
analyze, by using an emotion analysis unit, text input or voice input from the user to identify an emotional state of the user, and adjust at least one of contents and expressions of the prompt sentence and the response sentence according to the emotional state.

### (Supplementary 2)

The system according to supplementary 1,
wherein the processor is configured to
cause the distribution unit to dynamically allocate the natural language input and the prompt sentence to at least one of the business processing unit, the electronic transaction processing unit, and the emotion analysis unit based on the application content and the transaction type identified by the natural language processing unit and based on processing type information contained in the prompt sentence generated by the prompt generation unit.

### (Supplementary 3)

The system according to supplementary 1,
wherein the processor is configured to
cause the prompt generation unit to store, as a conversation history, a plurality of natural language inputs from the user and past processing histories corresponding to the plurality of natural language inputs, to generate, based on input information including the conversation history, a context-dependent prompt sentence that explicitly specifies a processing target and processing conditions, and to instruct the business processing unit and the electronic transaction processing unit to execute specific processing procedures according to the context-dependent prompt sentence.

### Example 2

### (Supplementary 1)

A system comprising a processor,
wherein the processor is configured to
receive application matters expressed in natural language from a user by using an interactive agent unit,
analyze the natural language input of the application matters acquired via the interactive agent unit, convert the analyzed natural language input into structured text data, and classify the application matters into business categories based on the structured text data by using an information processing unit,
manage business processing procedures corresponding to the business categories specified by the information processing unit, and automatically start and control the business processing procedures by using a process flow management unit,
search management information and application history information stored in a data storage device in association with processing by the process flow management unit, and store and update records including search results by using an information storage control unit,
analyze text input and voice input of the user, and specify an emotional state of the user by using natural language processing techniques by using an emotion analysis unit,
generate a prompt sentence based on business processing results obtained by the information processing unit and the process flow management unit, management information acquired by the information storage control unit, and contextual information including the natural language input of the user, transmit the prompt sentence to a generative AI model disposed externally or internally, and generate information necessary for a procedure by using generated information acquired from the generative AI model by using an information generation unit,
integrate the information generated by the information generation unit and the business processing results produced by the process flow management unit, and notify the user of integrated information via the interactive agent unit by using a reporting unit, and
dynamically change execution conditions, execution order, and notification contents of tasks in the process flow management unit based on the prompt sentence and the generated information generated by the information generation unit, so as to optimize business processing by using a business optimization unit.

### (Supplementary 2)

The system according to supplementary 1,
wherein the processor is configured to
analyze the application matters from the user by using the structured text data in the information processing unit, perform processing allocation to the process flow management unit and the emotion analysis unit according to the business categories, and record allocation results in association with the information storage control unit.

### (Supplementary 3)

The system according to supplementary 1,
wherein the processor is configured to
acquire operation information and procedural know-how accumulated through internal business processing from the information storage control unit in the information generation unit, generate a prompt sentence including the operation information and the procedural know-how and provide the prompt sentence to the generative AI model, instruct specific processing contents in business processing means based on the generated information acquired from the generative AI model, and make the operation information and the procedural know-how outputtable as system configuration information for external use.

### Application Example 2

### (Supplementary 1)

A system comprising a processor,
wherein the processor is configured to
execute an interactive agent for receiving application matters from a user by acquiring natural language data transmitted from a communication terminal, and to control a dialog with the user via the communication terminal,
analyze the received natural language data by using a natural language processing technique to perform at least morphological analysis, part-of-speech analysis, semantic analysis, and entity extraction, and generate structured data including at least an application type, a period, a quantity, and an identifier,
determine an intention of the application matters on the basis of the structured data and select, from among a plurality of business processing units, at least one business processing unit, and distribute the structured data to the selected business processing unit,
estimate an emotional state of the user by using at least one emotion analysis algorithm or at least one emotion analysis service on the basis of text input data and voice input data of the user, and generate and record emotion information including at least an emotion label and an emotion score as a result of the estimation,
change at least one of a processing priority, a processing procedure, and processing content on the basis of the emotion information and the structured data, and dynamically adjust at least one of a business load and a processing order for the user,
read and write, from and to at least one storage device or external information processing device, at least one of user attribute information, application history information, inventory information, and business progress information, and perform arithmetic operations and logical operations to execute at least one of an application permission determination, an inventory threshold determination, and a schedule determination,
periodically acquire the inventory information, compare an inventory amount of each target article with a threshold value, identify a target article whose inventory amount is below the threshold value, and generate replenishment request information related to the identified target article,
generate, on the basis of at least the structured data, the emotion information, and a business processing result, a prompt sentence for input to a generative AI model, and format the prompt sentence into request data conforming to a predetermined communication protocol,
transmit, as a generative AI linkage, the prompt sentence generated by a prompt generation unit to an external generative AI model, acquire response data output from the generative AI model, and extract, from the response data, at least one of structured information to be used for a business processing and a natural language message for the user,
complement or correct the business processing result on the basis of the structured information acquired from the generative AI model, or generate, by using the natural language message acquired from the generative AI model, at least one of an explanatory sentence, a proposal sentence, and an instruction sentence related to the business processing result,
transmit, as a notification, a message generated on the basis of the business processing result to the communication terminal via the interactive agent, and cause the message to be reported to the user in at least one of a display format and a voice format, and
accumulate, as knowledge data, at least a dialog history with the interactive agent, the structured data, the emotion information, the prompt sentence, and the response data from the generative AI model, and generate, on the basis of the knowledge data, at least one of procedure information of the business processing and a response template, and manage the at least one of the procedure information and the response template as know-how information that is externally providable.

### (Supplementary 2)

The system according to supplementary 1,
wherein the processor is configured to, on the basis of the emotion information obtained by the emotion analysis and the inventory information obtained by the periodic monitoring, increase a processing priority of application matters related to a user when the user is in at least one of a dissatisfaction state and a high-stress state, and control the prompt generation so as to cause the generative AI model to generate a rest recommendation message for a worker when the worker is in a fatigue state.

### (Supplementary 3)

The system according to supplementary 1,
wherein the processor is configured to generate a prompt sentence for instructing the generative AI model to create at least one of a summary of a business procedure and a standard response procedure on the basis of dialog history information, business processing result information, and emotion information accumulated in the knowledge data, and to register a document acquired via the generative AI linkage as business know-how that is externally providable.

What is claimed is:

1. A system comprising:
circuitry configured to:
receive, via a communication interface coupled to a packet-switched network, input information expressed in natural language from a terminal device, convert the input information into a structured data format, and store the structured data in a storage device;
analyze the structured data using a natural language processing model to identify a user intent and missing items of required parameter data, and retrieve, from the storage device, workflow definition information corresponding to the user intent;
generate context information for a generative neural network model based on the workflow definition information and the missing items of required parameter data, execute inference processing using the generative neural network model with the context information as input to generate a query sentence for acquiring the missing items, and transmit the query sentence to the terminal device via the communication interface;
receive additional input information from the terminal device in response to the query sentence, extract required parameter data from the additional input information using the natural language processing model, and store the required parameter data as workflow data for progressing the workflow corresponding to the user intent; and
complete the workflow based on the stored workflow data and transmit a completion result to the terminal device via the communication interface.

2. The system according to claim 1, wherein the circuitry is configured to analyze the structured data by applying intent classification processing to identify the user intent, and applying slot-filling processing to identify the missing items of required parameter data.

3. The system according to claim 2, wherein the circuitry is configured to generate the context information by embedding the workflow definition information, the identified user intent, and the missing items of required parameter data as structured fields in a context template for the generative neural network model.

4. The system according to claim 3, wherein the circuitry is configured to store the context information, the generated query sentence, and the additional input information as interaction history data in the storage device, and include the interaction history data in subsequent context information.

5. The system according to claim 4, wherein the circuitry is configured to iteratively generate query sentences and receive additional input information until all required parameter data for the workflow is acquired.

6. The system according to claim 5, wherein the circuitry is configured to update the missing items of required parameter data after each receipt of additional input information, and terminate the iterative query generation when no missing items remain.

7. The system according to claim 1, wherein the circuitry is configured to detect an affective state of the user from the input information using an affective recognition model, and adjust a query sentence style parameter based on the detected affective state to improve user engagement.

8. The system according to claim 7, wherein the circuitry is configured to include the detected affective state as a constraint in the context information to cause the generative neural network model to generate a query sentence adapted to the affective state of the user.

9. The system according to claim 1, wherein the circuitry is configured to distribute the input information to a workflow processing unit associated with the identified user intent based on a routing table derived from the workflow definition information.

10. The system according to claim 9, wherein the circuitry is configured to execute the workflow based on the stored workflow data by invoking workflow processing operations specified in the workflow definition information.

11. The system according to claim 1, wherein the circuitry is configured to convert the input information into the structured data format by applying tokenization, part-of-speech tagging, and entity extraction to the natural language input information.

12. The system according to claim 11, wherein the circuitry is configured to store the structured data comprising at least a user identifier, an intent label, a set of extracted entity values, and a timestamp in the storage device.

13. The system according to claim 1, wherein the circuitry is configured to generate a packaging data structure comprising the workflow definition information, the context generation logic, and accumulated interaction history data, for reuse in subsequent workflow deployments.

14. The system according to claim 13, wherein the circuitry is configured to transmit the packaging data structure to an external terminal device via the communication interface for deployment in a distinct processing environment.

15. The system according to claim 1, wherein the circuitry is configured to store the workflow data and the completion result as record information in the storage device, and update workflow definition information based on the stored record information.

16. The system according to claim 15, wherein the circuitry is configured to compute performance metrics from the record information, including at least one of completion time metrics and required-parameter extraction accuracy metrics, and update slot-filling processing parameters based on the computed performance metrics.

17. The system according to claim 1, wherein the circuitry is configured to retrieve, from the storage device, prior interaction history data associated with similar user intent and workflow definition information using a similarity search, and incorporate the retrieved data as context in the context information.

18. A system comprising:
circuitry configured to:
receive, via a communication interface coupled to a packet-switched network, natural language input information from a terminal device, apply tokenization and entity extraction to convert the input information into structured data, and analyze the structured data using a natural language processing model to identify a user intent and missing items of required parameter data;
retrieve workflow definition information corresponding to the user intent from a storage device, generate context information embedding the workflow definition information and the missing items, and execute inference processing using a generative neural network model to generate a query sentence for acquiring the missing items;
transmit the query sentence to the terminal device via the communication interface, receive additional input information, extract required parameter data from the additional input information, and store the required parameter data as workflow data; and
complete the workflow based on the stored workflow data, transmit a completion result to the terminal device via the communication interface, and update workflow definition information based on stored record information comprising completion results and extracted parameter accuracy metrics.

19. The system according to claim 18, wherein the circuitry is configured to iteratively generate query sentences and receive additional input information until all required parameter data is acquired, and update the missing items of required parameter data after each receipt of additional input information.

20. A method comprising:
receiving, via a communication interface coupled to a packet-switched network, input information expressed in natural language from a terminal device, converting the input information into a structured data format, and storing the structured data in a storage device;
analyzing the structured data using a natural language processing model to identify a user intent and missing items of required parameter data, and retrieving, from the storage device, workflow definition information corresponding to the user intent;
generating context information for a generative neural network model based on the workflow definition information and the missing items of required parameter data, executing inference processing using the generative neural network model with the context information as input to generate a query sentence for acquiring the missing items, and transmitting the query sentence to the terminal device via the communication interface;
receiving additional input information from the terminal device in response to the query sentence, extracting required parameter data from the additional input information using the natural language processing model, and storing the required parameter data as workflow data for progressing the workflow corresponding to the user intent; and
completing the workflow based on the stored workflow data and transmitting a completion result to the terminal device via the communication interface.
